(19) United States
(12) Patent Application Publication
(10) Pub. No.: US 2023/0180763 A1
(43) Pub. Date: Jun. 15, 2023

(54) NON-CHLORINATED OXIDIZING BIOCIDE CHEMISTRIES, THEIR METHODS OF PRODUCTION, APPLICATION AND METHODS OF FEED THEREOF

(71) Applicant: ECOLAB USA INC., Saint Paul, MN (US)

(72) Inventors: Amit Gupta, Saint Paul, MN (US); Harshada Ramesh Lohokare, Maharashtra (IN); Yogesh Suresh Bhole, Maharashtra (IN)

(21) Appl. No.: 18/166,800

(22) Filed: Feb. 9, 2023

Related U.S. Application Data
(62) Division of application No. 16/402,571, filed on May 3, 2019.
(60) Provisional application No. 62/666,778, filed on May 4, 2018.
(60) Provisional application No. 62/666,831, filed on May 4, 2018.

(51) Int. Cl. A01N 59/12; A01N 25/08; A01N 59/00; C02F 1/72; C02F 1/76

(52) U.S. Cl. CPC A01N 59/12; A01N 25/08; A01N 59/00; C02F 1/722; C02F 1/766; C02F 2303/04

(57) ABSTRACT

Biocides produced in situ for various applications of use are disclosed. Methods of generating and feeding thereof for various applications of use are disclosed according to the invention. In an aspect, oxidizing, non-chlorinated halogenated biocides are provided.

### CROSS REFERENCE TO RELATED APPLICATIONS

This is a divisional application of U.S. Ser. No. 16/402,571, filed May 3, 2019, which claims priority under 35 U.S.C. § 119 to U.S. Provisional Application Ser. No. 62/666,778 filed on May 4, 2018, entitled NON-CHLORINATED OXIDIZING BIOCIDE CHEMISTRIES, THEIR METHODS OF PRODUCTION, APPLICATION AND METHODS OF FEED THEREOF, and further claims priority under 35 U.S.C. § 119 to provisional application Ser. No. 62/666,831 filed May 4, 2018, and entitled LIQUID NON-CHLORINATED OXIDIZING BIOCIDE CHEMISTRIES, THEIR METHODS OF PRODUCTION, APPLICATION AND METHODS OF FEED THEREOF.

### FIELD OF THE INVENTION

The present disclosure relates generally to biocides, and more particularly to in situ methods of production of solid and/or liquid biocides, application and feed thereof for various applications of use. Beneficially, non-chlorinated halogenated biocides are provided.

### BACKGROUND OF THE INVENTION

Oxidizing biocides, including chlorine gas, hypochlorous acid, and bromine derived biocides, are frequently used to control the growth of microbial organisms and other biological deposit formations in aqueous systems. The use of oxidizing biocides in biofouling control methods is well established as fouling in industrial water systems occurs even in systems having water treatment programs and has a detrimental impact on the systems, in large part due to the microbial contamination which can establish microbial communities on any wetable or semi-wetable surface of the water system. Oxidizing biocides are effective biofouling control agents so long as they are maintained at effective concentrations in the water. Unless the concentrations of the biocides are effectively monitored, improper levels result in undesired microbial growth, scaling, corrosion, environmental impact, and increased cost that limit industrial applicability. Both oxidizing and non-oxidizing biocides are common in use; however the oxidizing biocides are preferred due to their non-specificity, speed of kill, cost effectiveness, and ease of monitoring.

Chlorine is commonly used in water and industrial processes for controlling the growth of microorganisms. Chlorine is a preferred halogen biocide due to its low cost, broad spectrum and fast biocidal activity, and convenience of monitoring and control. However, there are limitations for use of chlorine, including corrosion and/or degradation of system components, destruction of other water treatment additives, and environmental concerns, such as those associated with discharge of chlorine and chlorinated components. Accordingly there are limitations to the applications of use for chlorine.

Improvements to chlorine include the use of ammonium salts as practical compositions for stabilizing chlorine and using nitrogenous compounds to form chloramines. Chloramines have improved biocidal properties compared to chlorine, particularly against biofilm and filamentous organisms. However, chloramines impose a number of drawbacks on their use, including the fact that the produced chloramine must be immediately used and cannot be stored for future use because it is subject to rapid degradation. Therefore, chloramine must be generated outside of the system being treated and must be rapidly piped in to the system.

Other developments in industrial water treatment include incorporating higher pH values and corrosion inhibitors to use with non-chlorinated biocides, such as bromine. Bromine has been used in biofouling control usually through addition of sodium bromide to the water system with an oxidizing agent such as chlorine gas or sodium hypochlorite, generating hypobromous acid. However, many of the same compounds and conditions that reduce chlorine effectiveness also reduce bromine effectiveness. In addition, both liquid and solid bromine formulations require activation on-site using chlorine based chemistries or are supplied as activated in a stabilized liquid form. Disadvantages to solid formulations of brominated chemistries include, for example, presence of chlorine as an activating agent, moisture sensitivity which may cause run-away reactions, low solubility, high capital cost or equipment limitations, and safety and low application ease, particularly for dose control.

Accordingly, there remains an increasing concern from both an asset integrity and environmental discharge perspective regarding the generation and use of chlorinated compounds for treating aqueous systems. Beneficially, it is an aspect of the present invention to provide alternative halogenated non-chlorinated chemistries and methods of generating and use of the same.

According to an aspect of the invention, non-chlorine biocides having the desirable characteristics of an oxidizer, activity at a higher pH, stability of precursors, simple, safe and sustainable precursors and chemistries, high solubility, measurable for ease in monitoring and control, and new commercial offerings are provided.

In a still further aspect, solid non-chlorine biocides providing an alternative oxidation of bromide using non-chlorinated oxidants are provided.

In a still further aspect, solid non-chlorine biocides providing an alternative oxidation of iodide using non-chlorinated oxidants are provided.

Other objects, advantages and features of the present invention will become apparent from the following specification taken in conjunction with the accompanying drawings.

### BRIEF SUMMARY OF THE INVENTION

In an embodiment, the present invention is directed to a solid or liquid oxidizing, non-chlorinated halogenated biocide composition, wherein the composition is a one or more part system comprising: a halogen source, wherein the halogen source is not chlorine; an oxidizing agent, wherein the oxidizing agent is a non-chlorine containing oxygen donor; and, where the composition is a solid, a solidification agent. The compositions can further include additional functional components as disclosed herein. In an aspect, the biocide composition is stable for at least about 6 months, or for at least about 12 months. In an aspect, the liquid compositions do not require feed devices employed for solid compositions and allow for ease in mixing of the liquid compositions through various blending techniques.

In an embodiment, the present invention is directed to a solid or liquid oxidizing, non-chlorinated halogenated biocide composition, wherein the composition is a one or more part system comprising: a halogen source, wherein the halogen source is not chlorine; an oxidizing agent, wherein the oxidizing agent is a non-chlorine containing oxygen donor; a stabilizing agent; and, where the composition is a solid, a solidification agent, wherein the biocide composition is stable for at least about 6 months, or for at least about 12 months.

In an embodiment, the present invention is directed to a method of producing and employing a solid, oxidizing, non-chlorinated halogenated biocide composition comprising: providing the solid biocide composition; either (a) diluting the solid biocide composition to form a biocide use solution or (b) combining the two or three part solid biocide composition to generate the biocide use solution in situ; allowing all the reagents of the solid biocide composition to come into contact and mix with each other; and contacting the use solution to a surface or water system in need of microbial and macrofouling control.

In an aspect, the surface or water system contacted by the use solution is a potable water system, hot and cold water system, decorative fountain, fruit and vegetable wash, rinse and/or mist system, flume water system, industrial cooling water system, sea water, on-site point of use blending system for cleaning and sanitation, industrial process water system or combinations thereof. In a further aspect, the process water system is a reverse osmosis (RO) membrane systems, raw water treatment, food and beverage clean-in-place (CIP) application, treatment of waste water systems, ballast water systems, machine chests, head box waters, yellow or gray water systems, automotive wash water systems, metal working fluids, shower water, washers, thermal processing waters, brewing liquids, fermentation liquids, hard surface sanitization liquids, ethanol/bio-fuels process waters, pretreatment and utility waters, membrane system liquids, ion-exchange bed liquids, water used in the process/manufacture of paper, ceiling tiles, fiber board, or microelectronics, E-coat liquids, electrodeposition liquids, process cleaning liquids, oil exploration services liquids, oil well completion fluids, oil well workover fluids, drilling additive fluids, oil fracturing fluids, treated oil fracturing fluids, oil and gas wells, flowline water systems, natural gas water systems, and any combination thereof.

In still other embodiments, the method of producing and employing a solid, oxidizing, non-chlorinated halogenated biocide composition can optionally comprise a reagent or precursor of the solid biocide composition being introduced to the other components of the solid biocide composition through contacting with a water system containing the reagent or precursor, and thereafter combining the two or three part solid biocide composition to generate the biocide use solution in situ in allowing all the reagents of the solid biocide composition to come into contact and mix with each other. In an exemplary embodiment, a water system such as sea water or a treated facturing fluid, may contain a reagent or precursor required for the generation of the oxidizing, non-chlorinated halogenated biocide composition. Thereafter, upon generation of the oxidizing, non-chlorinated halogenated biocide composition in a use solution, such use solution can be contacted to a surface or further water system in need of microbial and macrofouling control.

In an embodiment, the present invention is directed to a method of producing and employing a liquid, oxidizing, non-chlorinated halogenated biocide composition comprising: providing the one or more part liquid biocide composition by; either (a) diluting the liquid biocide composition to form a biocide use solution or (b) combining the two or three part liquid biocide composition to generate the biocide use solution in situ; allowing all the reagents of the liquid biocide composition to come into contact and mix with each other; and contacting the use solution to a surface or water system in need of microbial and macrofouling control. In an additional embodiment, at least one of the two or three part liquid biocide composition could alternatively be provided as a solid reagent for combination with the liquid components. However, in a preferred aspect, the combination by blending or otherwise mixing of the liquid components are preferred. In an aspect, the surface or water system contacted by the use solution is a potable water system, hot and cold water system, decorative fountain, fruit and vegetable wash, rinse and/or mist system, flume water system, industrial cooling water system, sea water, on-site point of use blending system for cleaning and sanitation, industrial process water system or combinations thereof. In a further aspect, the process water system is a reverse osmosis (RO) membrane systems, raw water treatment, food and beverage clean-in-place (CIP) application, treatment of waste water systems, ballast water systems, machine chests, head box waters, yellow or gray water systems, automotive wash water systems, metal working fluids, shower water, washers, thermal processing waters, brewing liquids, fermentation liquids, hard surface sanitization liquids, ethanol/bio-fuels process waters, pretreatment and utility waters, membrane system liquids, ion-exchange bed liquids, water used in the process/manufacture of paper, ceiling tiles, fiber board, or microelectronics, E-coat liquids, electrodeposition liquids, process cleaning liquids, oil exploration services liquids, oil well completion fluids, oil well workover fluids, drilling additive fluids, oil fracturing fluids, treated oil fracturing fluids, oil and gas wells, flowline water systems, natural gas water systems, and any combination thereof.

In still other embodiments, the method of producing and employing a liquid, oxidizing, non-chlorinated halogenated biocide composition can optionally comprise a reagent or precursor of the liquid biocide composition being introduced to the other components of the liquid biocide composition through contacting with a water system containing the reagent or precursor, and thereafter combining the two or three part liquid biocide composition to generate the biocide use solution in situ in allowing all the reagents to come into contact and mix with each other. In an exemplary embodiment, a water system such as sea water or a treated fracturing fluid, may contain a reagent or precursor required for the generation of the oxidizing, non-chlorinated halogenated biocide composition. Thereafter, upon generation of the oxidizing, non-chlorinated halogenated biocide composition in a use solution, such use solution can be contacted to a surface or further water system in need of microbial and macrofouling control.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a drawing of a separate addition method of producing non-chlorinated halogenated biocides using a wide space in the blending lines or a batch method.

FIG. 2 is a drawing of a continuous dilution method of producing non-chlorinated halogenated biocides using a wide space in the blending lines or a batch method.

FIG. 3 is a drawing of a prior mixing method of producing dilute non-chlorinated halogenated biocides using a wide space in the blending lines or a batch method.

FIG. 4 is a drawing of a prior mixing and subsequent dilution method of producing non-chlorinated halogenated biocides using a wide space in the blending lines or a batch method.

FIGS. 5-7 are drawings of a sequential addition method of producing dilute non-chlorinated halogenated biocides.

FIGS. 8-11 are drawings of alternating addition methods of introducing non-chlorinated halogenated biocides into a system to be treated.

FIGS. 12-13 are drawings of a second alternating feeding addition methods of introducing non-chlorinated halogenated biocides into a system to be treated.

FIGS. 14-19 are drawings of a third form of alternating feeding addition method of introducing non-chlorinated halogenated biocides into a system to be treated where the components are added at the same location in the conduit.

FIGS. 20-24 are graphs showing the efficacy of non-chlorine biocides compared to control (no biocide) and chlorine at varying times and pH ranges according to embodiments of the invention.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The embodiments of this invention are not limited to the exemplary non-chlorinated oxidizing biocidal chemistries and methods of producing the same, which can vary and are understood by skilled artisans based upon the disclosure set forth herein. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

“Asynchronous Mixing” refers to mixing such that over a discrete period of time the amount or concentration of a material mixed and then fed into a system fluctuates. Asynchronous Mixing of biocides is more likely to result in the particular formulation ideal for killing the particular organism present and it also creates a dynamic environment which makes it difficult for organisms to adapt to.

The terms “automatic,” “automatically,” “automated,” and other similar terms refer to a method or portion thereof that is performed without human intervention or substantially without human intervention. For example, a process carried out automatically (i.e., an “automated process”) would measure a variable and take action (e.g., change a pump speed, open or close a valve, increase heating or cooling, etc.) based on a comparison of the measured variable to a standard value (i.e., a setpoint or a steady state calculation) without a person having to do anything to make the action take place, outside of initially providing all necessary equipment, plumbing, wiring, power, programming, ingredients, and so forth.

“Batch Process” refers to chemical process in which only a finite number of reagents can be fed into a reaction operation over a period of time having a discrete start time and end time and which produces a finite amount of product.

The term “biocide” refers to a substance that is used to kill microbiological organisms or at least inhibit microbiological function (e.g., growth and/or reproduction) that may be present in a second substance.

“Biocide demand” refers to the amount of biocide needed to overcome the consumption of the biocide by microbiological and non-microbiological components present and inhibit microbial fouling, which can be monitored based on one or more of several variables described herein.

“Channeling” refers to a process in which mixture of materials flowing through a line separates into different flowing layers sorted by density, viscosity, temperature or some other property. Channeling can be prevented by use of a wide space in the mixing line.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

“Continuous Process” refers to an ongoing chemical process, which is capable of theoretically continuing over an unlimited period of time in which reagents can be continuously fed into a reaction operation to continuously produce product. Continuous Process and Batch Process are mutually exclusive.

As used herein, the term “disinfectant” refers to an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15^{th} Edition, 1990 (EPA Guideline 91-2). As used herein, the term “high level disinfection” or “high level disinfectant” refers to a compound or composition that kills substantially all organisms, except high levels of bacterial spores, and is effected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

As used herein, “dosing” is a species of “treating.” Dosing refers to the continuous, semi-continuous, or intermittent combining of a biocide according to the embodiments of the Invention. Treatment refers to combining of a biocide and an aqueous liquid that has a biocide demand, or applying the biocide to a surface, even if the combining does not happen in a continuous fashion or on a regular basis. In certain embodiments according to the invention, treatment occurs by introducing a biocide in solid or liquid form into an aqueous liquid (water source to be treated) or to a surface. “Fouling” and “contamination” refer to the undesirable presence of or deposition of any organic or inorganic material in the water or on a surface, including any extraneous or undesirable organic or inorganic material in water or on surfaces. “Microbial fouling” refers to the presence or deposition of any extraneous or undesirable microbiological organisms or their products in water or on a surface. The term “hard surface” refers to a solid, substantially non-flexible surface such as a counter top, tile, floor, wall, panel, window, plumbing fixture, kitchen and bathroom furniture, appliance, engine, circuit board, and dish. Hard surfaces may include for example, health care surfaces and food processing surfaces. As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, fixtures or structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.), or fabric surfaces, e.g., knit, woven, and non-woven surfaces (such as surgical garments, draperies, bed linens, bandages, etc.), or patient-care equipment (such as respirators, diagnostic equipment, shunts, body scopes, wheel chairs, beds, etc.), or surgical and diagnostic equipment. Health care surfaces include articles and surfaces employed in animal health care.

As used herein, the term “instrument” refers to the various medical or dental instruments or devices that can benefit from cleaning with a composition according to the present invention. As used herein, the phrases “medical instrument,” “dental instrument,” “medical device,” “dental device,” “medical equipment,” or “dental equipment” refer to instruments, devices, tools, appliances, apparatus, and equipment used in medicine or dentistry. Such instruments, devices, and equipment can be cold sterilized, soaked or washed and then heat sterilized, or otherwise benefit from cleaning in a composition of the present invention. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, scopes (e.g., endoscopes, stethoscopes, and arthoscopes) and related equipment, and the like, or combinations thereof.

For the purpose of this patent application, successful microbial reduction is achieved when the microbial populations are reduced by at least about 50%, or by significantly more than is achieved by a wash with water. Larger reductions in microbial population provide greater levels of protection.

“Monitor” means a device constructed and arranged to measure at least one physical or chemical characteristic and to output a signal or display in response to that measurement.

“Oxidizing Halogen” refers to a halogen bearing composition of matter including but not limited to chlorine, bromine or iodine derivatives, most preferably a chlorine or bromine derivative such as hypochlorous acid or hypobromous acid. When referring to the compositions, methods of generating and applications of use relating to the present invention, oxidizing halogens are specifically referencing non-chlorinated halogenated biocides.

As used herein, the term “sanitizer” refers to an agent that reduces the number of bacterial contaminants to safe levels as judged by public health requirements. In an embodiment, sanitizers for use in this invention will provide at least a 3 log reduction and more preferably a 5-log reduction. These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log reduction) within 30 seconds at room temperature, 25±2° C., against several test organisms.

As used herein, the term “soil” or “stain” refers to a non-polar oily substance which may or may not contain particulate matter such as mineral clays, sand, natural mineral matter, carbon black, graphite, kaolin, environmental dust, etc.

As used in this invention, the term “sporicide” refers to a physical or chemical agent or process having the ability to cause greater than a 90% reduction (1-log reduction) in the population of spores of Bacillus cereus or Bacillus subtilis within 10 seconds at 60° C. In certain embodiments, the sporicidal compositions of the invention provide greater than a 99% reduction (2-log reduction), greater than a 99.99% reduction (4-log reduction), or greater than a 99.999% reduction (5-log reduction) in such population within 10 seconds at 60° C.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can affect two kinds of microbial cell damage. The first is a lethal, irreversible action resulting in complete microbial cell destruction or incapacitation. The second type of cell damage is reversible, such that if the organism is rendered free of the agent, it can again multiply. The former is termed microbiocidal and the later, microbistatic. A sanitizer and a disinfectant are, by definition, agents which provide antimicrobial or microbiocidal activity. In contrast, a preservative is generally described as an inhibitor or microbistatic composition

As used herein, “stream” refers to a flowing liquid. A non-limiting example of a stream is an aqueous liquid flowing through a pipe.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

“Wide Space” refers to an area in the mixing line where the diameter of the line is larger than the largest individual reagent supply line leading into it and in which the transition from the smaller to larger diameter is not streamlined, whereby when a liquid flows into this area the change in diameter results in eddies which mix the fed materials in an erratic manner and prevents channeling. This wide space allows for adequate mixing, functioning differently than a standard conduit. The wide space could be an isolated batch tank.

The methods, systems, apparatuses, and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions. It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

Compositions

Oxidizing, non-chlorinated halogenated biocide formulations, whether solid or liquid, according to the invention may include a single, double or triple chemistry. In an aspect, the non-chlorinated halogenated biocide formulations are a single solid or a single liquid chemistry. In an aspect, the non-chlorinated halogenated biocide formulations are a double solid or a double liquid chemistry. In an aspect, the non-chlorinated halogenated biocide formulations are a triple solid or triple liquid chemistry.

In still other aspects, the single or double chemistry (one or two part chemistry) can be combined with a second or third aqueous reagent or precursor of the biocide composition to produce the oxidizing, non-chlorinated halogenated biocide composition. In such an aspect, a reagent or precursor of the biocide composition can be introduced as an aqueous component with the other components of the biocide composition through contacting with a water system containing the reagent or precursor, and thereafter combining the two or three part biocide composition to generate the biocide use solution in situ in allowing all the reagents of the biocide composition to come into contact and mix with each other. In an exemplary embodiment, a water system such as sea water or a treated facturing fluid, may contain a reagent or precursor required for the generation of the oxidizing, non-chlorinated halogenated biocide composition. Thereafter, upon generation of the oxidizing, non-chlorinated halogenated biocide composition in a use solution, such use solution can be contacted to a surface or further water system in need of microbial and macrofouling control.

In an aspect, the solid formulations according to the invention having a single, double or triple chemistry are stable for at least about 3 months, at least about 4 months, at least about 5 months, at least about 6 months, at least about 7 months, at least about 8 months, at least about 9 months, at least about 10 months, at least about 11 months, or at least about 12 months. In a preferred aspect, the formulations according to the invention having a single chemistry are stable for at least about 6 months. As referred to herein, stability refers to the dimensional and chemical stability of the composition. In an embodiment, “dimensional stability” and “dimensionally stable” as used herein, refer to a solid product having a growth exponent of less than about 3%, or preferably less than about 2% over the period of time under ambient storage conditions, preferably under room temperature storage conditions. Growth exponent refers to the percent growth or swelling of a product over a period of time after solidification under normal transport/storage conditions.

Without being limited according to a particular embodiment of the invention, when the composition is a liquid, it is preferred to employ a liquid chemistry that employs as few parts due to the increase in complexity involved in a three or more part chemistry. For example, the increase in number of distinct parts of the liquid chemistry requires increases pipes, drums and the like for a system employing the chemistry. Accordingly, a two-part liquid chemistry or a one-part liquid chemistry (e.g. stabilized sodium bromide wherein an oxidized bromide and stabilizer are provided in a one-part system, wherein the stabilizer binds bromine to form an equilibrium with hyperbromous acid) is preferred.

In an aspect, the formulations according to the invention are substantially-phosphate free and/or nitrilotriacetic acid (NTA)-free. Substantially phosphate-free means a solid composition having less than approximately 0.5 wt-%, more particularly, less than approximately 0.1 wt-%, and even more particularly less than approximately 0.01 wt-% phosphate based on the total weight of the composition. NTA-free means a composition having less than approximately 0.5 wt-%, less than approximately 0.1 wt-%, and often less than approximately 0.01 wt-% NTA based on the total weight of the composition. Accordingly, the embodiments of the present invention providing phosphate-free and/or NTA-free compositions are particularly useful in cleaning applications where it is desired to use an environmentally friendly composition having environmentally friendly discharge profiles.

The biocide formulations according to the invention provide an aqueous composition having a pH of at least about 7, at least about 8, at least about 9, at least about 10, at least about 11, or at least about 12. The aqueous compositions can be diluted to a desired pH for an applicable application of use. In an aspect, the use solution of the biocide formulations have a pH preferably between about 7 and about 12, and more preferably between about 8 and about 10.

The formulations according to the invention can be formed into any suitable solid form. In an aspect, the solid composition is selected from the group consisting of a powder, a flake, a granule, an agglomerate, a pellet, a tablet, a lozenge, a puck, a briquette, a brick, a solid block, a unit dose, or another solid form known to those of skill in the art, or mixtures thereof.

In another aspect, the solid composition may be adapted to form a gel. In embodiments where the solid composition is provided in the form of a gel, the composition can be characterized as a suspension that behaves as an elastic solid or semi-solid rather than as a liquid. The gel can additionally be characterized as a solid dispersed in a liquid. A gel can exhibit a viscosity greater than water and can flow when a pressure is applied.

According to embodiments of the invention, the solid compositions are understood to mean a hardened composition that will not flow and will substantially retain its shape under moderate stress or pressure or mere gravity. The degree of hardness of the solid composition may range from that of a fused solid product which is relatively dense and hard, for example, like concrete, to a consistency characterized as being a hardened paste. In addition, the term “solid” refers to the state of the composition under the expected conditions of storage and use of the solid composition. In general, it is expected that the composition will remain in solid form when exposed to temperatures of up to approximately 100° F. and preferably up to approximately 122° F.

In an aspect, the solid, oxidizing, non-chlorinated halogenated biocide formulations according to the invention are produced by the oxidation of a halogen source to form a stabilized halogen biocide composition. In an aspect, the composition to form the solid non-chlorinated halogenated biocide formulations comprise, consist of and/or consist essentially of a halogen source, oxidizing agent, and solidification agent. In a further aspect, the composition to form the solid non-chlorinated halogenated biocide formulations comprise, consist of and/or consist essentially of a halogen source, oxidizing agent, solidification agent and stabilizing agent. In a still further aspect, the composition to form the solid non-chlorinated halogenated biocide formulations comprise, consist of and/or consist essentially of a halogen source, oxidizing agent, solidification agent, stabilizing agent, and an additional functional ingredient(s).

In an aspect, the liquid, oxidizing, non-chlorinated halogenated biocide formulations according to the invention are produced by the oxidation of a halogen source to form a stabilized halogen biocide composition. In an aspect, the composition to form the liquid non-chlorinated halogenated biocide formulations comprises, consists of and/or consists essentially of a halogen source and oxidizing agent. In a further aspect, the composition to form the liquid non-chlorinated halogenated biocide formulations comprises, consists of and/or consists essentially of a halogen source, oxidizing agent and stabilizing agent. In a still further aspect, the composition to form the liquid non-chlorinated halogenated biocide formulations comprises, consists of and/or consists essentially of a halogen source, oxidizing agent, stabilizing agent, and an additional functional ingredient(s). Water can be included in the formulations for the liquid non-chlorinated halogenated biocide formulations.

Exemplary ranges of the non-chlorinated halogenated biocide compositions according to the invention are shown in Table 1 in weight percentage of the compositions for a one-part composition.

TABLE 1

| | First | Second | Third | Fourth |
|---|---|---|---|---|
| | Exemplary | Exemplary | Exemplary | Exemplary |
| | Range wt- | Range wt- | Range wt- | Range wt- |
| Material | % | % | % | % |
| Halogen Source | 1-98 | 5-80 | 10-70 | 25-50 |
| Oxidizing Agent | 1-98 | 5-80 | 10-70 | 25-50 |
| Solidification Agent | 0-25 | 0-25 | 0-25 | 0-25 |
| Additional Functional | 0-50 | 0-40 | 0-25 | 0-10 |
| Ingredients | | | | |

As one skilled in the art will ascertain, the compositions can be a one-part composition, or a multiple-part compositions. In various embodiments a multiple-part composition is employed, such as the halogen source and oxidizing source may be combined from separate compositions. Accordingly, the molar ratio of the components impacts the generation of the non-chlorinated halogenated biocides according to the invention.

The compositions according to the invention have a molar ratio of halogen source to oxidizing agent from about 10:1 to about 0.1:1, or from about 7.5:1 to about 1:1, or from about 5:1 to about 1:1, or from about 2:1 to about 1:1, or from about 1.5:1 to about 1:1, or from about 1.5:1 to about 6:1, or preferably from about 1.5:1 to about 3:1.

The oxidizing, non-chlorinated halogenated biocide formulations according to the invention may be provided in a multiple-part solid or liquid chemistry. In an aspect, the non-chlorinated halogenated biocide formulations are a single solid or liquid chemistry.

In another aspect, the non-chlorinated halogenated biocide formulations are a double solid chemistry, such that a first solid chemistry comprises, consists of and/or consists essentially of the halogen source (and optionally the stabilizing agent), and the second solid chemistry comprises, consists of and/or consists essentially of oxygen donor. In another aspect, the non-chlorinated halogenated biocide formulations are a double solid chemistry, such that a first solid chemistry comprises, consists of and/or consists essentially of the halogen source and oxygen donor, and the second solid chemistry comprises, consists of and/or consists essentially of the stabilizing agent. In such an embodiment, the combination of the two part solid compositions upon dilution will result in the production of the non-chlorinated halogen biocide chemistry. In the various embodiments of the invention each party of the solid chemistry may further comprise, consist of and/or consist essentially of solidification agents and other additional functional ingredients.

In an aspect, the non-chlorinated halogenated biocide formulations are a triple solid chemistry such that a first solid chemistry comprises, consists of and/or consists essentially of the halogen source, the second solid chemistry comprises, consists of and/or consists essentially of the oxygen donor, and the third solid chemistry comprises, consists of and/or consists essentially of the stabilizing agent. In such an embodiment, the combination of the three part solid compositions upon dilution will result in the production of the non-chlorinated stabilized halogen biocide chemistry. In the various embodiments of the invention each party of the solid chemistry may further comprise, consist of and/or consist essentially of solidification agents and other additional functional ingredients.

In an aspect, the non-chlorinated halogenated biocide formulations are provided in a two-part liquid chemistry, such that a first chemistry comprises, consists of and/or consists essentially of the halogen source (and optionally the stabilizing agent), and the second solid chemistry comprises, consists of and/or consists essentially of oxygen donor. In another aspect, the non-chlorinated halogenated biocide formulations are a two-part liquid chemistry, such that a first chemistry comprises, consists of and/or consists essentially of the halogen source and oxygen donor, and the second chemistry comprises, consists of and/or consists essentially of the stabilizing agent. In such an embodiment, the combination of the two part liquid compositions upon contacting and reaction will result in the production of the non-chlorinated halogen biocide chemistry.

In an aspect, the non-chlorinated halogenated biocide formulations are a three-part liquid chemistry such that a first chemistry comprises, consists of and/or consists essentially of the halogen source, the second chemistry comprises, consists of and/or consists essentially of the oxygen donor, and the third chemistry comprises, consists of and/or consists essentially of the stabilizing agent. In such an embodiment, the combination of the three part liquid compositions upon contact will result in the production of the non-chlorinated stabilized halogen biocide chemistry.

Halogen Source

The oxidizing non-chlorinated biocide compositions comprise a halogen source. In an aspect, the halogen source is a non-chlorine, non-chloride, and/or salt thereof. In an aspect, the halogen source is bromide, iodide, salts thereof, and/or combinations thereof. In an aspect, the bromide salt can be bromide salts of alkali earth metals, such as sodium or potassium bromide, or other compounds, such as calcium bromide, ammonium bromide, brominated urea, or other brominated compounds. In an aspect, the iodide salt can be iodide salts of alkali earth metals, such as sodium or potassium iodide, or other compounds, such as ammonium iodide, iodine urea, or other iodine containing compounds.

In a further aspect, the halogen source can include an ammoniated halide salt, such as ammonium bromide, ammonium iodide, or brominated quaternary ammonium compounds. In such an embodiment, the ammoniated halide salt is oxidized to form an additional biocidal product, such as a bromamine.

In an aspect, the compositions comprise a halogen source in the amount of from about 1 wt-%-98 wt-%, from about 5 wt-%-80 wt-%, from about 10 wt-%-70 wt-%, or preferably from about 25 wt-%-50 wt-% in the composition (in reference to a single composition). In addition, without being limited according to the invention, all ranges recited are inclusive of the numbers defining the range and include each integer within the defined range. As one skilled in the art will ascertain from the disclosure herein, the halogen source provided in a composition provides the source of the halide ion to produce the oxidizing halogen component after reacting with the oxygen source (oxidizing agent) disclosed herein.

Oxidizing Agent

The oxidizing non-chlorinated biocide compositions comprise an oxidizing agent. As referred to herein, the oxidizing agent is an oxygen donor for the oxidation of the halogen source. According to the invention the oxidizing agent is a non-chlorine containing oxygen donor. In some embodiments, the oxidizing agent has biocidal activity on its own accord. In other embodiments, the oxidizing agent does not have biocidal activity independent of the generated oxidizing biocide composition.

In an aspect, the oxidizing agent is selected from the group consisting of hydrogen peroxide, peroxy acids, mono peroxy sulfate salts, persulfate salts, percarbonate salts, perborate salts, and combinations thereof. In a preferred aspect, the oxidizing agent is a hydrogen peroxide donor or hydrogen peroxide. In a further preferred aspect, the oxidizing agent is a mono peroxy sulfate salt, such as an alkali metal peroxymonosulfate salt, including potassium peroxymonosulfate (also referred to as oxone).

Examples of inorganic oxidizing agents include the following types of compounds or sources of these compounds, or alkali metal salts including these types of compounds, or forming an adduct therewith: hydrogen peroxide, urea-hydrogen peroxide complexes or hydrogen peroxide donors of: group 1 (IA) oxidizing agents, for example lithium peroxide, sodium peroxide; group 2 (IIA) oxidizing agents, for example magnesium peroxide, calcium peroxide, strontium peroxide, barium peroxide; group 12 (IIB) oxidizing agents, for example zinc peroxide; group 13 (IIIA) oxidizing agents, for example boron compounds, such as perborates, for example sodium perborate hexahydrate of the formula Na₂ [B₂ (O₂)₂(OH)₄]6H₂O (also called sodium perborate tetrahydrate); sodium peroxyborate tetrahydrate of the formula Na₂B₂(O₂)₂[(OH)₄]4H₂O (also called sodium perborate trihydrate); sodium peroxyborate of the formula Na₂[B₂(O₂)₂(OH)₄] (also called sodium perborate monohydrate); group 14 (IVA) oxidizing agents, for example persilicates and peroxycarbonates, which are also called percarbonates, such as persilicates or peroxycarbonates of alkali metals; group 15 (VA) oxidizing agents, for example peroxynitrous acid and its salts; peroxyphosphoric acids and their salts, for example, perphosphates; group 16 (VIA) oxidizing agents, for example peroxysulfuric acids and their salts, such as peroxymonosulfuric and peroxydisulfuric acids, and their salts, such as persulfates, for example, sodium persulfate; and group VIIa oxidizing agents such as sodium periodate. Other active inorganic oxygen compounds can include transition metal peroxides; and other such peroxygen compounds, and mixtures thereof.

In some embodiments, the compositions of the present invention employ one or more of the inorganic oxidizing agents listed above. Suitable inorganic oxidizing agents include ozone, hydrogen peroxide, hydrogen peroxide adduct, group IIIA oxidizing agent, or hydrogen peroxide donors of group VIA oxidizing agent, group VA oxidizing agent, group VIIA oxidizing agent, or mixtures thereof. Suitable examples of such inorganic oxidizing agents include percarbonate, perborate, persulfate, perphosphate, persilicate, or mixtures thereof.

In an aspect, the compositions comprise an oxidizing agent in the amount of from about 1 wt-%-98 wt-%, from about 5 wt-%-80 wt-%, from about 10 wt-%-70 wt-%, or preferably from about 25 wt-%-50 wt-% in the solid composition (in reference to a single composition). In an embodiment, the compositions are produced by the oxidation of a halogen source by providing an oxidizing agent in the amounts described herein. In addition, without being limited according to the invention, all ranges recited are inclusive of the numbers defining the range and include each integer within the defined range. As one skilled in the art will ascertain from the disclosure herein, the oxidizing agent will produce the oxidizing halogen component when reacted with the halogen source providing the halide ion.

Solidification Agent

In an aspect, the solid compositions include one or more inert solidification agents which do not contribute to biocidal activity of the compositions. Solidification agents may also be referred to as thickeners herein. Suitable solidification agents include celluloses, carbonates, urea, inorganic hydratable salts, organic hydratable salts, inert thickeners, and the like.

In an aspect, the solidification agent is a polysaccharide or a polysaccharide based thickener or solidification agent. Suitable polysaccharides include, for example, alginates, starches, and cellulosic polymers (e.g., carboxymethyl cellulose, hydroxyethyl cellulose, and the like).

In an aspect, the solidification agent may include urea, including urea particles. For example, a particulate form of urea may be employed. The amount and particle size of the urea is effective to combine with the biocide to form a homogeneous mixture without the application of heat from an external source to melt the urea and other ingredients to a molten stage. The amount of urea included in the solid composition should be effective to provide a desired hardness and desired rate of solubility of the composition when placed in an aqueous medium to achieve a desired rate of dispensing the solidified composition during use.

In an aspect, the solidification agent may include inert thickeners, including natural gums such as xanthan gum, guar gum, modified guar, or other gums from plant mucilage. In another aspect, the solidification agent may include polyacrylates thickeners; and hydrocolloid thickeners, such as pectin.

In an aspect, the solidification agent is at least one hydratable salt, inorganic or organic. In an embodiment the hydratable salt is an alkali metal carbonate. In one embodiment the hydratable salt is sodium carbonate (soda ash or ash). In another aspect, the solidification agent is an inorganic hydratable salt. In certain embodiments, the hydratable salt agent may include, but are not limited to: alkali metal hydroxides, alkali metal phosphates, anhydrous sodium sulfate, anhydrous sodium acetate, silicates, metasilicates, and other known hydratable inorganic compounds or combinations thereof. The amount of hydratable salt necessary to enhance solidification depends upon several factors, including the exact solidifying agent employed, the amount of water in the composition, and the hydration capacity of the other components.

In an aspect, the compositions are produced by inclusion of a solidification agent in the amount of from about 0 wt-%-25 wt-%, from about 1 wt-%-25 wt-%, from about 1 wt-%-20 wt-%, from about 5 wt-%-25 wt-%, or from about 5 wt-%-20 wt-% in the solid composition (in reference to a single solid composition). In addition, without being limited according to the invention, all ranges recited are inclusive of the numbers defining the range and include each integer within the defined range.

Additional Functional Ingredients

The components of the solid non-chlorinated halogenated biocide formulations can further be combined with various functional components suitable for particular biocidal applications of use. In some embodiments, the composition including the halogen source, oxidizing agent, and solidification agent make up a large amount, or even substantially all of the total weight of the solid composition. For example, in some embodiments few or no additional functional ingredients are disposed therein.

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in antimicrobial applications, including cleaning and sanitizing applications. However, other embodiments may include functional ingredients for use in other applications.

In some embodiments, the compositions do not include additional functional ingredients. In preferred embodiments, the compositions do not include any chlorinated components and the compositions are chlorine-fee biocidal compositions.

In other embodiments, the compositions may include additional functional ingredients selected from the group consisting of water, stabilizing agents, corrosion inhibitors, scale inhibitors, pH modifiers, including alkalinity source and/or acid source, defoaming agents, anti-redeposition agents, bleaching agents, surfactants and/or detergents, solubility modifiers, dispersants, rinse aids, metal protecting agents, sequestrants and/or chelating agents, additional solidification and/or stabilizing components, fragrances and/or dyes, including sensing or tracing dyes, rheology modifiers or thickeners, hydrotropes or couplers, buffers, solvents and the like.

In an aspect, the solid compositions can further include additional functional ingredients in an amount of from about 0 wt-%-50 wt-%, from about 0 wt-%-40 wt-%, from about 0 wt-%-25 wt-%, or from about 0 wt-%-10 wt-%. In still other aspects, the solid compositions can further include additional functional ingredients in an amount of from about 0.1 wt-%-50 wt-%, from about 1 wt-%-40 wt-%, from about 1 wt-%-25 wt-%, or from about 1 wt-%-10 wt-% in any solid composition. In addition, without being limited according to the invention, all ranges recited are inclusive of the numbers defining the range and include each integer within the defined range.

Water

The compositions according to the invention may comprise water in amounts that vary depending upon whether the composition is provided as a solid or liquid, and where the composition is a solid, further based upon techniques for processing the solid composition, such as pressed, extruded, cast solid, etc.

Where the composition is a liquid, water may be independently added to each part of the liquid composition and/or used to dilute the generated liquid, oxidizing, non-chlorinated halogenated biocide composition. The amount of water in the resulting liquid composition is between about 0% and about 75% by weight, between about 0.1% and about 50% by weight, or between about 1% and about 50% by weight. Without limiting the scope of the invention, the numeric ranges recited are understood to be inclusive of the numbers defining the range and include each integer within the defined range.

Where the composition is a solid, water may be independently added to the solidification matrix or may be provided in the solidification matrix as a result of its presence in an aqueous material that is added to generate the solid composition. For example, materials added to the composition may include water or may be prepared in an aqueous premix available for reaction with the solidification matrix component(s). Typically, water is introduced into the solidification matrix to provide the solidification matrix with a desired viscosity for processing prior to solidification and to provide a desired rate of solidification. The water may also be present as a processing aid and may be removed or become water of hydration. The water may thus be present in the form of aqueous solutions of the solidification matrix, or aqueous solutions of any of the other ingredients, and/or added aqueous medium as an aid in processing. In addition, it is expected that the aqueous medium may help in the solidification process when is desired to form the concentrate as a solid. The water may also be provided as deionized water or as softened water.

The amount of water in the resulting solid composition will depend on whether the solid composition is processed through forming techniques, such as a pressed solid, or casting (solidification occurring within a container) techniques. In general, when the components are processed by forming techniques, it is believed that the solid composition can include a relatively smaller amount of water for solidification compared with the casting techniques.

Dyes—Sensing Agents

In some embodiments, the compositions of the present invention include a sensing or tracing dye. In such embodiments, a dye is employed that imparts color or has spectral properties such as fluorescence is added to the composition to track the quantity added to the reaction or in the process being treated. The added dye or chemical compound could be tracked and monitored using photometric methods such as a fluorometer or a spectrophotometer or using spectral properties at specific wavelengths.

The sensing agents can further include a fluorophore as the sensing or tracing dye. A fluorophore has a characteristic peak excitation and emission wavelength and can be used in combination with another fluorophore having a different characteristic peak excitation and emission wavelength, wherein the emission spectra can overlap. The fluorophore can include a rhodamine, rhodamine B, N,N,N′,N′ tetramethyl carboxyrhodamine (TAMRA), 6-carboxy-X-rhodamine (ROX), 6-carboxyrhodamine (R6G), Rhodamine Green, Rhodamine Red, 4,7-dichlorotetramethyl rhodamine (DTAMRA), lissaminerhodamine B sulfonyl chloride rhodamine (Rhod), rhodamine 123, rhodamine X, Alexa dyes (e.g., Alexa Fluor-350, -430, -488, -532, -546, -568, -594, -663 and -660), DyLight 594, isothiocyanate, sulforhodamine B, sulforhodamine 101, sulfonyl chloride derivative of sulforhodamine 101 (Texas Red); tetramethyl rhodamine; tetramethyl rhodamine isothiocyanate (TRITC), fluorescein, 6-carboxyfluorescein (6-FAM), 5-carboxyfluorescein (5-Fam), 5- or 6-carboxy-4,7,2′,7′-tetrachlorofluorescein (TET), 5- or 6-carboxy-4′5′2′4′5′7′ hexachlorofluorescein (HEX), 5′ or 6′-carboxy-4′,5′-dichloro-2,′7′-dimethoxyfluorescein (JOE),6-JOE, 5-carboxy-2′,4′,5′,7′-tetrachlorofluorescein (ZOE) rhodol, fluorescein isothiocyanate, cyanine dyes, including Cy2, Cy 3, Cy3B, Cy 3.5, Cy 5, Cy 5.5, Cy 7 and Cy 7.5, carbocyanine, dicarbocyanine, merocyanine, coumarin, 7-amino-4-methylcoumarin, aminocoumarin, hydroxycoumarin, 4-dicyanomethylene-2-methyl-6-(p(dimethylamino)styryl)-4H-pyran (DCM), pyrromethene, stilbene, umbelliferone, tetracene, malachite green, macrocyclic chelates of lanthanide ions (e.g., quantum dye, etc.), AMCA, BODIPY 630/650, BODIPY 650/665, BODIPY-FL, BODIPY-R6G, BODIPY-TMR, BODIPY-TRX, Oregon Green 488, Oregon Green 500, Oregon Green 514, Pacific Blue, PicoGreen, eosins and erythrosins, phycocyanin, allophycocyanin, o-phthaldehyde, fluorescent nonparticles (e.g. Q dots) and fluorescamine, 8-anilino-1-napthalene sulfonate, Cascade blue, Cascade Yellow, Marina Blue, dimethylaminonaph-thalene sulfonic acid (dansyl), pyrene, anthracene, nitrobenz-oxadiazole (NBD), Auramine 0, acridine and dipyrrometheneboron difluoride, Acridine Orange, Acridine Yellow, an Atto dye, coelenterazine, 4′,6-diamidino-2-phenylindole (DAPI), FLUO 3, FURA 2,5-hydroxytryptamine (HAT), a Hoechst dye, INDO 1, JC-1 dye, Lucifer Yellow, Nile Red, propidium iodide, QUIN 2, or seminaphtharhodafluor (SNARF).

In embodiments according to the invention employing a sensing or tracing dye, the sensing or tracing dye is present in ranges of between about 0% and about 20% by weight, between about 0.001% and about 20% by weight, between about 0.001% and about 10% by weight, particularly between about 0.01% and about 5% by weight in the composition (in reference to a single composition) or within a use solution of the biocide generated from the compositions according to the invention. Without limiting the scope of the invention, the numeric ranges recited are understood to be inclusive of the numbers defining the range and include each integer within the defined range.

Stabilizing Agents

In some embodiments, the compositions of the present invention include a stabilizing agent. Stabilizing agents suitable for the compositions include compounds that interact with the halogen source to produce a halogenated compound that subsequently releases the free halogen. In some embodiments the interact with the halogen source to produce a halogenated compound that subsequently releases the free halogen forms an equilibrium with the free halogen form. In other embodiments, the interaction of the stabilizing agent with the halogen source does not result in an equilibrium with the free halogen form.

In an embodiment, a stabilizing agent is a sulfamate, a derivative of compound of sulfamic acid, isocyanurate, and/or hydantoin. In this aspect of the invention, a component that acts to react with the produce reactive halogen oxidant may be included. The component would be called a stabilizer since it would act to stabilize the produced halogen oxidizing chemistry. The stabilizing agent may be one that reacts with the produced oxidizing chemistry to stabilize it in the concentrated form and releases the halogen in a dilute form. The stabilized form in this instance does not in itself impart any significant biocidal activity but the biocidal activity is realized upon release of the oxidizing halogen chemistry from the stabilizer in solution. Alternatively, the stabilizer may react with the produced halogen chemistry to form a different oxidizing halogen chemistry that does provide biocidal kill efficacy in the combined/stabilized form.

Exemplary sulfamates, include for example, sodium sulfamate, potassium sulfamate, and derivatives compounds of sulfamic acid.

Exemplary isocyanurates, include for example, sodium dichloroisocyanurate, potassium dichloroisocyanurate, pentaisocyanurate, tris(2-hydroxy ethyl)isocyanurate triacrylate, isocyanurate di(meth)acrylate, and tris(acryloxyethyl)isocyanurate. In an aspect, an alkali metal dichloroisocyanurate is a preferred stabilizing agent.

Exemplary hydantoins, include for example, 1-[(oxiranylalkoxy)alkyl]hydantoin, 3-[(oxiranylalkoxy)alkyl]hydantoin, 1,3-bis[oxiranylalkoxy)alkyl]hydantoin, 1-[oxiranylalkoxy)alkyl]-5,5-dialkyl-hydantoin, 3-[oxiranylalkoxy)alkyl]-5,5-dialkyl-hydantoin, 1,3-bis[oxiranylalkoxy)alkyl]-5,5-dialkyl-hydantoin, 1-(dibutylaminoalkyl)hydantoin, 3-(dibutylaminoalkyl)hydantoin, 1,3-bis(dibutylaminoalkyl)hydantoin, 1-(dibutylaminoalkyl)-5,5-dialkyl-hydantoin, 3-(dibutylaminoalkyl)-5,5-dialkyl-hydantoin, 1,3-bis(dibutylaminoalkyl)-5,5-dialkyl-hydantoin, 1-(anilinoalkyl)hydantoin, 3-(anilinoalkyl)hydantoin, 1,3-bis(anilinoalkyl)hydantoin, 1-(anilinoalkyl)-5,5-dialkyl-hydantoin, 3-(anilinoalkyl)-5,5-dialkyl-hydantoin, 1,3-bis(anilinoalkyl)-5,5-dialkyl-hydantoin, 1-(morpholinoalkyl)hydantoin, 3-(morpholinoalkyl)hydantoin, 1,3-bis(morpholinoalkyl)hydantoin, 1-(morpholinoalkyl)-5,5-dialkyl-hydantoin, 3-(morpholinoalkyl)-5,5-dialkyl-hydantoin, 1,3-bis(morpholinoalkyl)-5,5-dialkyl-hydantoin, 1-(oxiranylalkyl)hydantoin, 3-(oxiranylalkyl)hydantoin, 1,3-bis(oxiranylalkyl)hydantoin, 1-(oxiranylalkyl)-5,5-dialkyl-hydantoin, 3-(oxiranylalkyl)-5,5-dialkyl-hydantoin, 1,3-bis(oxiranylalkyl)-5,5-dialkyl-hydantoin, 1-(alkoxyalkyl)hydantoin, 3-(alkoxyalkyl)hydantoin, 1,3-bis(alkoxyalkyl)hydantoin, 1-(alkoxyalkyl)-5,5-dialkyl-hydantoin, 3-(alkoxyalkyl)-5,5-dialkyl-hydantoin, 1,3-bis(alkoxyalkyl)-5,5-dialkyl-hydantoin, 1-(allyloxyalkyl)hydantoin, 3-(allyloxyalkyl)hydantoin, 1,3-bis(allyloxyalkyl)hydantoin, 1-(allyloxyalkyl)-5,5-dialkyl-hydantoin, 3-(allyloxyalkyl)-5,5-dialkyl-hydantoin, 1,3-bis(allyloxyalkyl)-5,5-dialkyl-hydantoin, 1-(propargyloxyalkyl)hydantoin, 3-(propargyloxyalkyl)hydantoin, 1,3-bis(propargyloxyalkyl)hydantoin, 1-(propargyloxyalkyl)-5,5-dialkyl-hydantoin, 3-(propargyloxyalkyl)-5,5-dialkyl-hydantoin, or 1,3-bis(propargyloxyalkyl)-5,5-dialkyl-hydantoin.

In embodiments according to the invention employing a stabilizing agent, the stabilizing agent is present in ranges of between about 0% and about 50% by weight, between about 0.1% and about 45% by weight, between about 1% and about 40% by weight, particularly between about 1% and about 25% by weight in the solid composition (in reference to a single solid composition), or in a use solution of the biocide generated from the solid composition according to the invention. Without limiting the scope of the invention, the numeric ranges recited are understood to be inclusive of the numbers defining the range and include each integer within the defined range.

Buffers

In some embodiments, the compositions of the present invention include a buffer. A suitable buffer for use with the invention includes, but is not limited to, imidazole, 1-methylimidazole, benzotriazole, triethylamine, diisopropylethylamine, diisopropyl amine, piperidine, piperazine, urea, morpholine, N,N,N′N′-tetramethylethylenediamine (TMEDA), 1,8 diazabicyclo[5.4.0]undec-7-ene (DBU), bicine, 1,2,4-triazole, benzotriazole, histidine, 1,4 diazabicyclo[2.2.2]octane, guanine, caffeine, pyridine or its derivatives such as 2,6-lutidine and dipyridyl, an acylated amine such as 1-acetyl imidazole or 1-acetylindole, an acetyl ethyleneglycol, an acetyl polyethyleneglycol, a polyamine, the conjugate base of imidazole, piperidine, piperazine, diisopropylamine, morpholine, citric acid, tartaric acid, taurine, benzotriazole, histidine, guanine, glycerol, ethylene glycol, propylene gylcol, polyethylglycol, polypropyleneglycol, a polyamine, and the sodium, potassium, lithium, calcium, magnesium, or ammonium salts of carbonate, percarbonate, bicarbonate, acetate, borate, tetraborate, hydroxide, sulfate, phosphate (dibasic or tribasic) ions, or any combinations thereof.

In embodiments according to the invention employing a buffer, the buffer is present in ranges of between about 0% and about 50% by weight, between about 0.1% and about 45% by weight, between about 1% and about 40% by weight, particularly between about 1% and about 30% by weight in the composition (in reference to a single composition), or in a use solution of the biocide generated from the composition according to the invention. Without limiting the scope of the invention, the numeric ranges recited are understood to be inclusive of the numbers defining the range and include each integer within the defined range.

Surfactants

In some embodiments, the compositions of the present invention include a surfactant and/or detergent. Without being limited to a particular mechanism of action, inclusion of a surfactant and/or detergent in the compositions of the invention may beneficially aid in the accessibility of the oxidizing agent of the composition, such as for example, reacting with organic deposites and improving penetration of the oxidizing agent into deposilt layers, such as a biofilm to be treated with the compositions of the invention.

Surfactants suitable for use with the compositions of the present invention include, but are not limited to, nonionic surfactants, anionic surfactants, amphoteric surfactants, cationic surfactants, and zwitterionic surfactants. One or the other class of surfactants may be excluded depending on the application. For example, in a water system being treated with anionic polymers for scale control, the use of cationic surfactants will be very undesirable. In embodiments employing a surfactant and/or detergent as an additional functional ingredient, the compositions can include about 0 wt % to about 50 wt % of a surfactant and/or detergent, or the compositions include about 0 wt % to about 25 wt % of a surfactant and/or detergent. In other embodiments the compositions of the present invention include about 0.1 wt % to about 20 wt % of a surfactant and/or detergent. In still yet other embodiments, the compositions of the present invention include about 1 wt % to about 20 wt % of a surfactant and/or detergent. The weight percentage can refer to the composition (in reference to a single composition) or within a use solution of the biocide generated from the compositions according to the invention. Without limiting the scope of the invention, the numeric ranges recited are understood to be inclusive of the numbers defining the range and include each integer within the defined range.

Nonionic Surfactants

Suitable nonionic surfactants for use with the compositions of the present invention include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

The semi-polar type of nonionic surface active agents is another class of nonionic surfactant useful in compositions of the present invention. Semi-polar nonionic surfactants include the amine oxides, phosphine oxides, sulfoxides and their alkoxylated derivatives.

Amine oxides are tertiary amine oxides corresponding to the general formula:

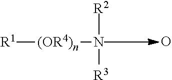

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkylene or a hydroxyalkylene group containing 2 to 3 carbon atoms; and n ranges from 0 to about 20. An amine oxide can be generated from the corresponding amine and an oxidizing agent, such as hydrogen peroxide.

Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Anionic Surfactants

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present compositions also include alkyl sulfonates, the linear and branched primary and secondary alkyl sulfonates, and the aromatic sulfonates with or without substituents.

Anionic carboxylate surfactants suitable for use in the present compositions include carboxylic acids (and salts), such as alkanoic acids (and alkanoates), ester carboxylic acids (e.g. alkyl succinates), ether carboxylic acids, and the like. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

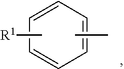

in which R is a C₈ to C₂₂ alkyl group or in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₅-C₁₆ alkyl group. In some embodiments, R is a C₁₂-C₁₄ alkyl group, n is 4, and m is 1.

In other embodiments, R is

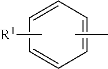

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g. the product Sandopan® DTC, a C₁₃ alkyl polyethoxy (7) carboxylic acid.

Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present invention have the general formula:

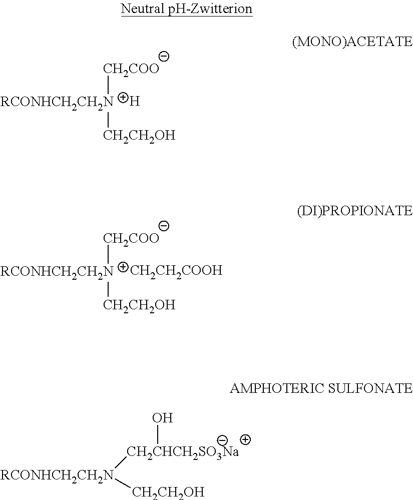

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R=C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this invention include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂-CH₂—CH₂-0H or C₁₂-alkyl-C(O)—N(H)—CH₂—CH₂—N⁺(CH₂—CO₂Na)₂-CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch).

Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong” inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

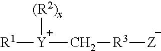

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio) hydroxy-propane-1-sulfonate; 4-[N,N-di(2(2-hydroxyethyl)-N(2-hydroxydodecyl)ammonio]-butane-1-carboxylate; 3-[5-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

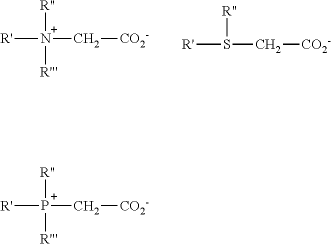

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines useful in the present invention include those compounds having the formula (R(R¹)₂N⁺ R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references is herein incorporated in their entirety.

In an embodiment, the compositions of the present invention include a betaine. For example, the compositions can include cocoamido propyl betaine.

Cationic Surfactants

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

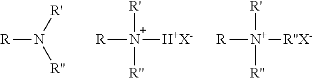

in which, R represents a long alkyl chain, R′, R″, and R′″ may be either long alkyl chains or smaller alkyl or aryl groups or hydrogen and X represents an anion. The amine salts and quaternary ammonium compounds are preferred for practical use in this invention due to their high degree of water solubility.

The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions of the present invention include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

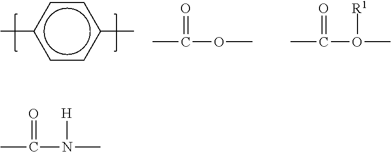

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens. Y is can be a group including, but not limited to:

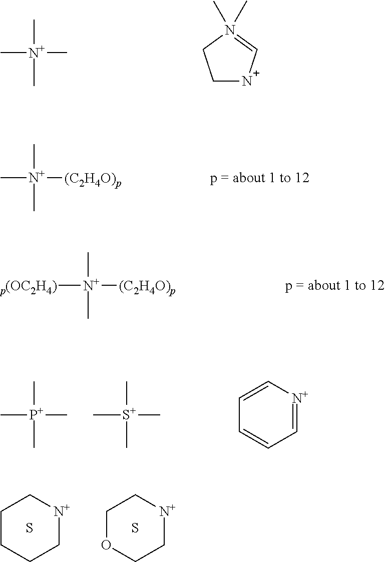

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

Additional Thickening Agents

Examples of suitable thickeners or rheology modifiers are polymeric thickeners including, but not limited to: polymers or natural polymers or gums derived from plant or animal sources. Such materials may be polysaccharides such as large polysaccharide molecules having substantial thickening capacity. Thickeners or rheology modifiers also include clays. A substantially soluble polymeric thickener can be used to provide increased viscosity or increased conductivity to the use compositions. Examples of polymeric thickeners for the aqueous compositions of the invention include, but are not limited to: carboxylated vinyl polymers such as polyacrylic acids and sodium salts thereof, ethoxylated cellulose, polyacrylamide thickeners, cross-linked, xanthan compositions, sodium alginate and algin products, hydroxypropyl cellulose, hydroxyethyl cellulose, and other similar aqueous thickeners that have some substantial proportion of water solubility.

Exemplary ranges of the additional thickening agents include up to approximately 20% by weight, between approximately 0.5% and approximately 15% by weight, and between approximately 2% and approximately 10% by weight.

Stabilizing Agents

Biocide compositions according to the present invention may include additional stabilizing agents. Examples of suitable stabilizing agents include, but are not limited to: borate, calcium/magnesium ions, propylene glycol, and mixtures thereof. The concentrate need not include a stabilizing agent, but when the concentrate includes a stabilizing agent, it can be included in an amount that provides the desired level of stability of the concentrate. Exemplary ranges of the stabilizing agent include up to approximately 20% by weight, between approximately 0.5% and approximately 15% by weight, and between approximately 2% and approximately 10% by weight.

Dispersants

Biocide compositions according to the present invention may include one or more dispersants. Examples of suitable dispersants that can be used in the solid biocide composition include, but are not limited to: maleic acid/olefin copolymers, polyacrylic acid, and mixtures thereof. The concentrate need not include a dispersant, but when a dispersant is included it can be included in an amount that provides the desired dispersant properties. Exemplary ranges of the dispersant in the concentrate can be up to approximately 20% by weight, between approximately 0.5% and approximately 15% by weight, and between approximately 2% and approximately 9% by weight.

Methods for Making a Liquid Composition

Liquid compositions formed according to the invention may be produced using a batch or continuous mixing system to contact the liquid components to form the liquid compositions. In some aspects, the chemistry is generated following combination of the liquid components of the composition, which can take a few minutes to a few hours.

Methods for Making a Solid Composition

Without being limited to a particular theory of the invention, various mechanisms for solidification of the biocide compositions according to the invention can be employed dependent upon the solidification agent employed. In an aspect, the solid composition is formed through ash hydration in embodiments employing a hydratable salt(s). In further aspects, the solid composition may be formed through additional methods of solidification matrix using polymers, such as are described in U.S. Pat. No. 7,763,576, the disclosure of which is incorporated by reference herein its entirety.

In another aspect, pressed solids may be formed and/or flowable powders.

Solid compositions formed according to the invention may be produced using a batch or continuous mixing system. In an exemplary embodiment, a single- or twin-screw extruder is used to combine and mix one or more agents at high shear to form a homogeneous mixture. In some embodiments, the processing temperature is at or below the melting temperature of the components. The processed mixture may be dispensed from the mixer by forming, casting or other suitable means, whereupon the composition hardens to a solid form. The structure of the matrix may be characterized according to its hardness, melting point, material distribution, crystal structure, and other like properties according to known methods in the art. Generally, a solid composition processed according to the method of the invention is substantially homogeneous with regard to the distribution of ingredients throughout its mass and is dimensionally stable.

Specifically, in a forming process, the liquid and solid components are introduced into the final mixing system and are continuously mixed until the components form a substantially homogeneous semi-solid mixture in which the components are distributed throughout its mass. In an exemplary embodiment, the components are mixed in the mixing system for at least approximately 5 seconds. The mixture is then discharged from the mixing system into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

Specifically, in a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

In some aspects, the solidification process may last from a few minutes to about six hours, depending on factors including, but not limited to: the size of the formed or cast composition, the ingredients of the composition, and the temperature of the composition.

According to embodiments of the invention, the solid detergent compositions according to the present invention is understood to mean a hardened composition that will not flow and will substantially retain its shape under moderate stress or pressure or mere gravity. The degree of hardness of the solid composition may range from that of a fused solid product which is relatively dense and hard, for example, like concrete, to a consistency characterized as being a hardened paste. In addition, the term “solid” refers to the state of the composition under the expected conditions of storage and use of the solid composition. In general, it is expected that the composition will remain in solid form when exposed to temperatures of up to approximately 100° F. and preferably up to approximately 122° F. The desired shape or form of the solid composition may be achieved through any of the several different methods such as, but not limited to pelletizing, pressing, extruding or casting.

Methods of Generating

In at least one embodiment a non-chlorinated halogenated biocide is generated by a process in which chemical reagents are introduced into a wide space for the production of the non-chlorinated halogenated biocide. In at least one embodiment one or more of the reagents are introduced either automatically via a controller device, such as a PLC device or a timer, or manually. Any number of measurements, individually or in combination, can be used to regulate the flow of reagents, including but not limited to tank volume, Oxidation-Reduction Potential (ORP), residual oxidant, pH, temperature, and microbial activity. As referred to herein, the wide space can take the shape of a plumbed wide zone in a conduit that is then connected to the process being treated or can be a separate container, for example a tank. A diluent which is any appropriate liquid including but not limited to water may also be streamed into the wide space.

A first reagent includes a halogen source, including a bromide salt, iodide salt, or an ammoniated halide salt (which are referred to herein as halide salts and are understood to exclude chloride salts). Bromide salts can be any bromide salts of alkali earth metals, such as sodium or potassium bromide, or other compounds, for example ammonium bromide, brominated urea, or other brominated compounds. Iodide salts can be any iodide salts of alkali earth metals, such as sodium or potassium iodide, or other iodine containing compounds. Ammoniated halide salts, such as ammonium bromide, ammonium iodide, or brominated quaternary ammonium compounds, can further be employed to produce additional biocide products such as bromamines.

A second reagent includes an oxidizing agent. Examples of non-chlorine containing oxidizing agent include hydrogen peroxide, mono peroxy sulfate salts, persulfate salts, percarbonate salts, and perborate salts. Beneficially, oxidizing agent may independently have biocidal activity in addition to the biocides generated pursuant to the invention.

A third optional reagent includes a stabilizer. Suitable stabilizing agents include, for example, sulfamates, isocyanurates, and hydantoins. Without being limited according to a mechanism of action, the stabilizing agent interacts with the halogen species producing a halogenated compound that releases the free halogen and may or may not form an equilibrium with the free halogen form.

Additional optional reagents can be included. In an aspect, an additional reagent includes a surfactant, polymer surfactant or detergent is included. Such an additional reagent can be combined with the first reagent, second reagent and/or third reagent according to the various embodiments of the invention. Such an additional reagent is desirable to aid in the accessibility of the oxidant. In a non-limiting embodiment of the non-chlorinated halogenated biocides, a surfactant, polymer surfactant and/or detergent may be suitable to react with organic deposits and improve penetration of the oxidizing agent into the deposit layers, such as biofilms, to provide improved biocidal efficacy.

Blending and Dilution

According to embodiments of the invention, the oxidizing, non-chlorinated halogenated biocide compositions are generated in situ through the blending of streams of chemistry. In an aspect, all concentrate streams are blended and fed. In another aspect, all concentrate streams are blended and diluted before feeding to a system for an application of use. In further aspect, one or two concentrate streams are blended with one or two dilute stream. In a further aspect, all dilute streams are blended. In a still further aspect, the blending of the streams may be synchronous or asynchronous, and/or continuous or intermittent.

According to embodiments of the invention, the solid, oxidizing, non-chlorinated halogenated biocide compositions are dissolved in one or more manners. In an aspect, the compositions are dissolved by flowing an aqueous or non-aqueous media over the solid composition (one or more parts). In a further aspect, the compositions are dissolved by spraying an aqueous or non-aqueous media over the solid composition. In a further aspect, the compositions are dissolved by dropping the solid chemistry into a stationary or flowing aqueous or non-aqueous media.

According to embodiments of the invention, the solid, oxidizing, non-chlorinated halogenated biocide compositions are dosed in either synchronous or asynchronous manner, and either a continuous or intermittent manner.

According to embodiments of the invention, the solid, oxidizing, non-chlorinated halogenated biocide compositions (as referred to here throughout in reference to the one-part, two-part and/or three-part compositions) can be applied to a system or surface in need of treatment as a biocide according to multiple embodiments. In an aspect, the solid compositions can be applied to the system by direct application without prior dissolution, for example by introducing the solid chemistry into a tank or a pipe of the system being treated and where gradual or rapid dissolution of the chemistry will occur to provide the biocidal properties. According to an embodiment, such approach is particularly well suited for a one-part solid composition.

In another aspect, the solid compositions can be dissolved and then dissolved product streams can be blended to produce the biocidal product. According to an embodiment, such approach is particularly well suited for a two or more part solid composition.

In another aspect, a single part composition is dissolved and the liquid stream is directly applied to a system for an application of use.

In another aspect, a single part composition or a two part composition are dissolved and then passed over one or two solid chemistries to produce dissolution within the same stream.

According to embodiments of the invention, the liquid, oxidizing, non-chlorinated halogenated biocide compositions are dosed in either synchronous or asynchronous manner, and either a continuous or intermittent manner.

According to embodiments of the invention, the liquid, oxidizing, non-chlorinated halogenated biocide compositions (as referred to here throughout in reference to the one-part, two-part and/or three-part compositions) can be applied to a system or surface in need of treatment as a biocide according to multiple embodiments. In an aspect, the liquid compositions can be applied to the system by direct application without prior dissolution, for example by introducing the liquid chemistry into a tank or a pipe of the system being treated and where gradual or rapid dissolution of the chemistry will occur to provide the biocidal properties. In another aspect, the multi-part liquid compositions can be contacted and blended to produce the biocidal product. According to an embodiment, such approach is particularly well suited for a two or more part composition.

In another aspect, a single part composition is provided and the liquid stream is directly applied to a system for an application of use.

In another aspect, a single part composition or a multi-part composition are contacted to generate the biocide within the same stream.

Additional description of devices and apparatus suitable for feeding, diluting and/or dispensing the biocide compositions according to the invention are set forth in U.S. Pat. No. 7,201,178, U.S. Publication Nos. 2008/0152578, 2008/0160604, 2011/0206597, 2012/0021062 each of which is incorporated herein by reference in its entirety.

Monitoring

The methods and applications of use herein would benefit from use of proper concentrations to promote efficient and effective use of the biocidal compositions, namely the use of a monitoring system. As referred to herein, “monitor” or “monitoring” refers to a system or device constructed and arranged to measure at least one physical or chemical characteristic and to output a signal or display in response to that measurement, such as for measuring a concentration of the biocides according to the invention. Exemplary monitoring many include the use of an system that provides real time up to date concentration information would be applicable. Various methods (and related apparatus, including commercially available devices) can be employed, including for example, colorimetric and indicator reagents, ORP, Amperometric measurements (using conductive element sensors), fluorometery, and the like. Various monitoring systems and devices can be employed and additional description of these is set forth for example in U.S. Publication No. 2016/0154411, which is herein in corporated by reference in its entirety.

Depicted Embodiments

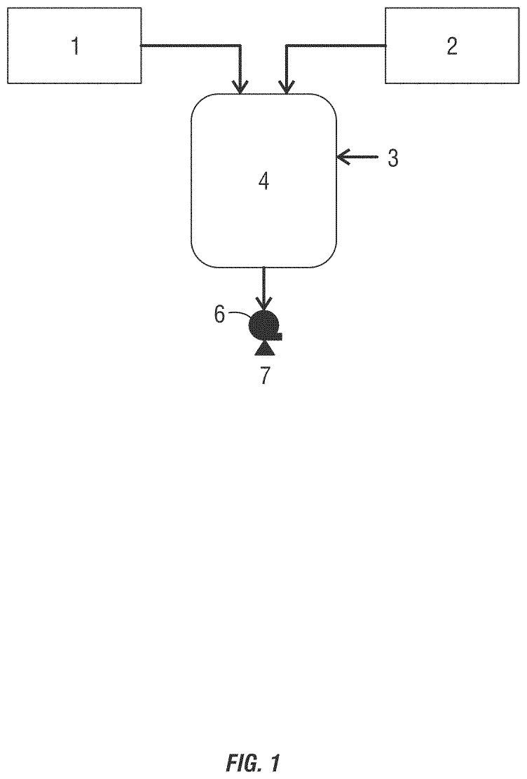

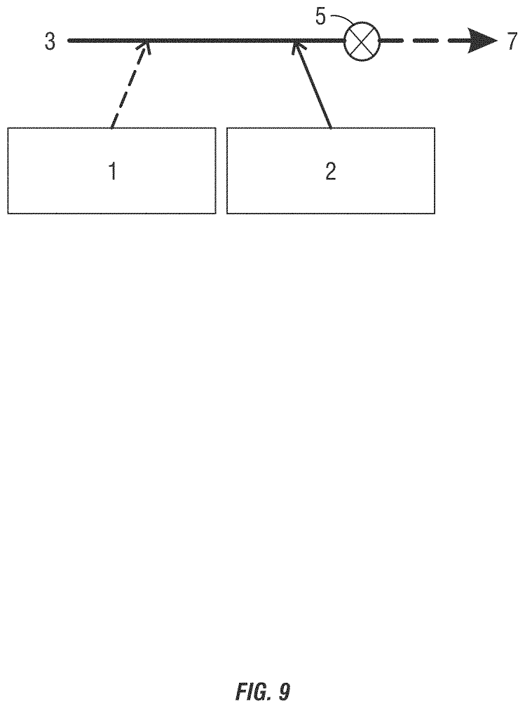

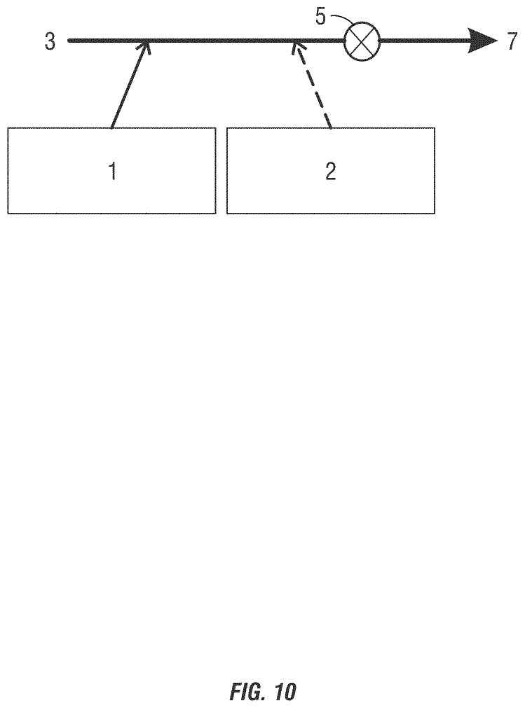

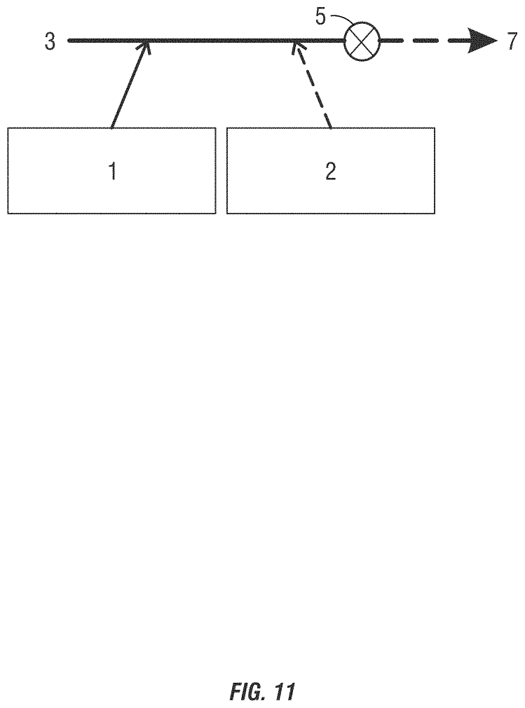

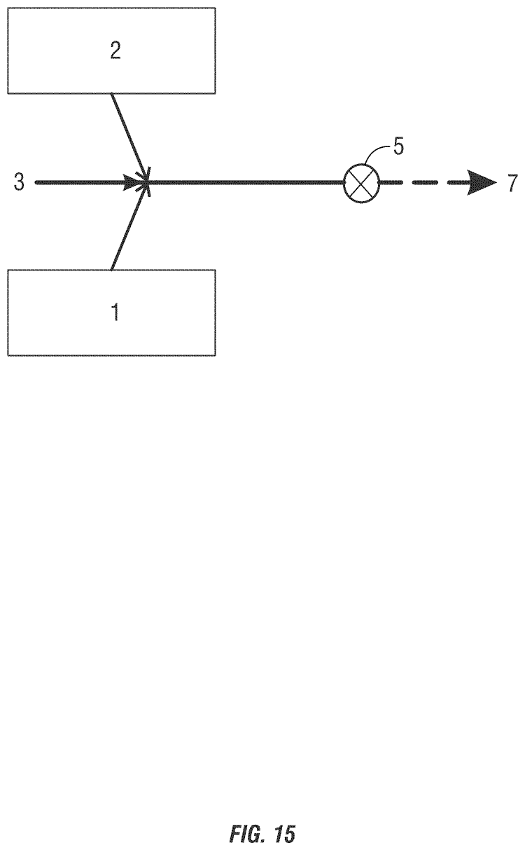

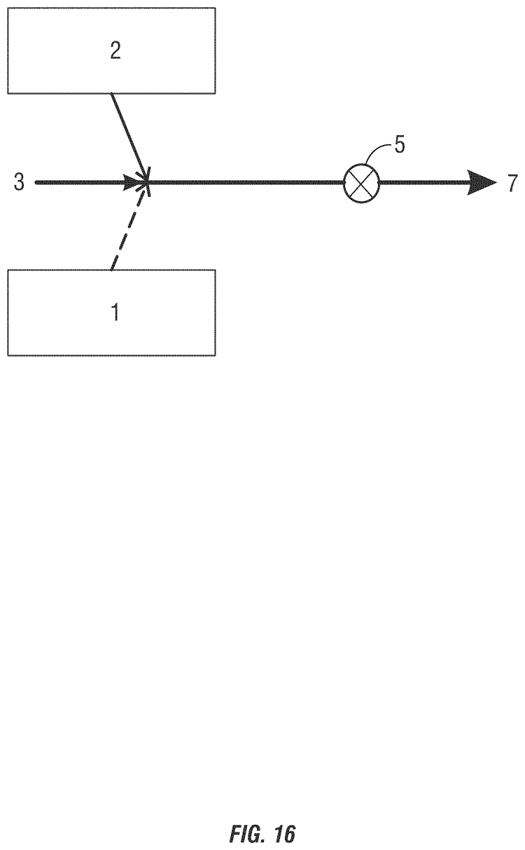

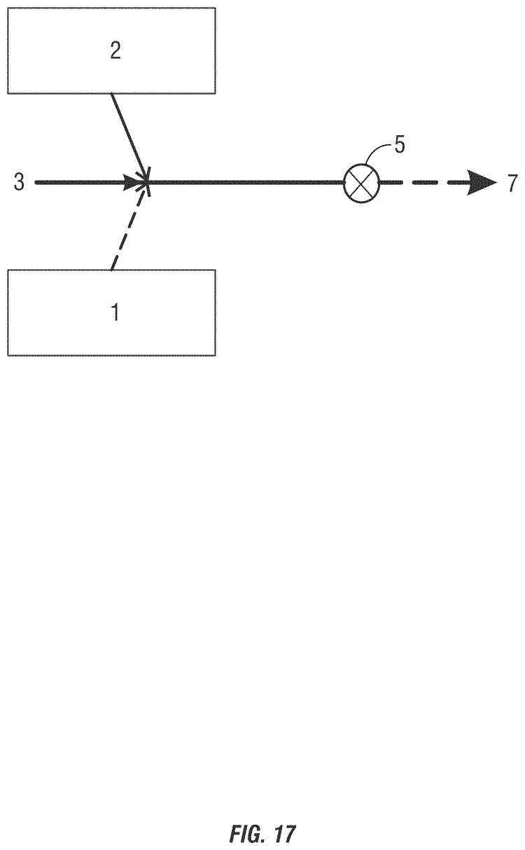

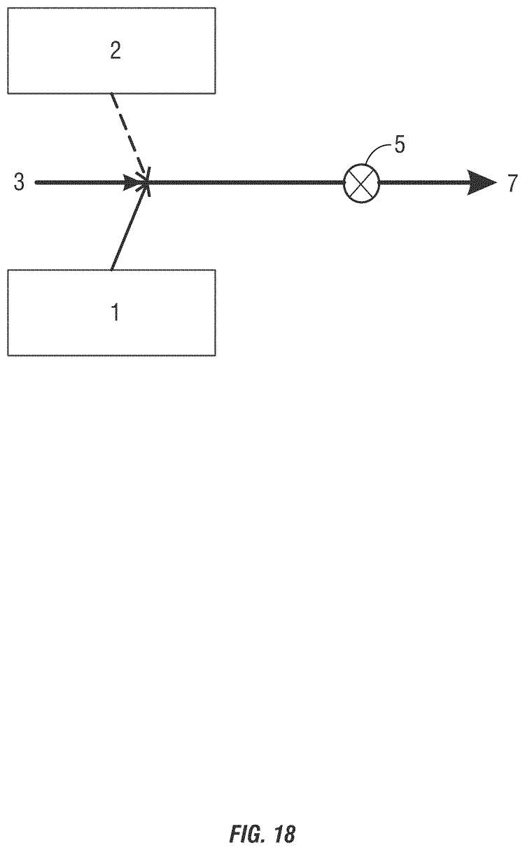

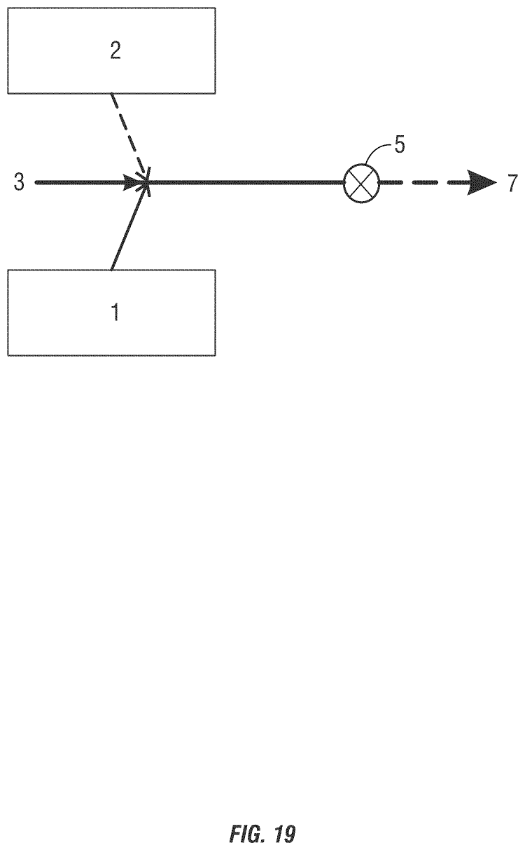

FIGS. 1-19 show a number of arrangements for an apparatus used in the methods of generating the non-chlorinated halogenated biocides of the present invention. These apparatuses involve the feeding of at least two reagent streams (depicted in the figures as 1, 2), or at least three reagent streams (not depicted as would include an additional input as 1, 2, X), into the wide space (4). As referred to herein, the reagent streams provide a chemistry composition according to the invention. According to an exemplary embodiment first reagent is a halogen source, such as a halide salt (1), for example a bromide salt of an alkali earth metal, an iodide salt of an alkali earth metal or an ammoniated halide salt. A second reagent is an oxidizing agent (or may also be referred to herein as an oxygen source) (2), for example hydrogen peroxide, mono peroxy sulfate salts, persulfate salts, percarbonate salts, or perborate salts. A third reagent is an optional stabilizing agent or stabilizer (X), for example sulfamates, isocyanurates, and hydantoins. As shown in the figures, the reagents may be combined into two-part (two-reagent) systems. As described herein according to the invention a three-part (three-reagent) system may similarly be employed. Although additional functional components may be formulated into the non-chlorinated halogenated biocides it is desirable to have a two-part system or three-part system for generating the non-chlorinated halogenated biocides. In an aspect, a liquid non-chlorinated halogen biocide is generated through a two reagent system including a first reagent halide salt and a second reagent oxygen donor. In other embodiments, the compositions of the invention can be a single formulated solid, oxidizing, non-chlorinated halogenated biocide composition.

In an aspect, a solid non-chlorinated halogen biocide is generated through a two reagent system including a first reagent halide salt and a second reagent oxygen donor.

In an aspect, a solid stabilized non-chlorinated halogen biocide is generated through a three reagent system including a first reagent halide salt, a second reagent oxygen donor, and a third reagent stabilizer.

In an aspect, two separate solid stabilized non-chlorinated chemistry formulations are combined to generate a biocide through a two reagent system including a first reagent halide salt and stabilizer, and a second reagent oxygen donor. According to this aspect of the invention, the use of a first reagent containing a halide salt and a stabilizer as a single formulation and a second reagent oxygen donor as a second formulation are blended to result in the production of the non-chlorinated halogen biocide chemistry.

In an aspect, two separate solid stabilized non-chlorinated chemistry formulations are combined to generate a biocide through a distinct two reagent system including a first reagent halide salt, and a second reagent oxygen donor and stabilizer. According to this aspect of the invention, the use of a first reagent containing a halide salt as a single formulation and a second reagent oxygen donor and a stabilizer as a second formulation are blended to result in the production of the non-chlorinated halogen biocide chemistry.

In an aspect, three separate solid stabilized non-chlorinated chemistry formulations are combined to generate a biocide through a distinct three reagent system including a first reagent halide salt, a second reagent oxygen donor, and a third reagent stabilizer. According to this aspect of the invention, the use of a first reagent containing a halide salt, a second reagent oxygen donor, and a third reagent stabilizer, each as a single, separate feed source, are blended to result in the production of the non-chlorinated halogen biocide chemistry.

In an aspect, a liquid stabilized non-chlorinated halogen biocide is generated through a three reagent system including a first reagent halide salt, a second reagent oxygen donor, and a third reagent stabilizer.

In an aspect, two separate liquid (or a combination of a liquid and a solid) stabilized non-chlorinated chemistry formulations are combined to generate a biocide through a two reagent system including a first reagent halide salt and stabilizer, and a second reagent oxygen donor. According to this aspect of the invention, the use of a first reagent containing a halide salt and a stabilizer as a single formulation and a second reagent oxygen donor as a second formulation are blended to result in the production of the non-chlorinated halogen biocide chemistry.

In an aspect, two separate liquid stabilized non-chlorinated chemistry formulations are combined to generate a biocide through a distinct two reagent system including a first reagent halide salt, and a second reagent oxygen donor and stabilizer. According to this aspect of the invention, the use of a first reagent containing a halide salt as a single formulation and a second reagent oxygen donor and a stabilizer as a second formulation are blended to result in the production of the non-chlorinated halogen biocide chemistry.

In an aspect, three separate liquid stabilized non-chlorinated chemistry formulations are combined to generate a biocide through a distinct three reagent system including a first reagent halide salt, a second reagent oxygen donor, and a third reagent stabilizer. According to this aspect of the invention, the use of a first reagent containing a halide salt, a second reagent oxygen donor, and a third reagent stabilizer, each as a single, separate feed source, are blended to result in the production of the non-chlorinated halogen biocide chemistry.

During the combination and mixing of the reagents (1), (2), and/or (X, not shown in figures which depict two-part solid compositions for exemplary purposes) come into contact with a diluent (3). In at least one embodiment the diluent comprises water. In at least one embodiment the diluent comprises As referred to herein, the reagents (1), (2) and/or (X) can be added in varying combinations and in varying formulations of the solid chemistry components, and the depiction in the figures referring to (1), (2) and/or (X) are set forth for purposes of depicting means of addition and not with any limitation to the formulations thereof with respect to any particular reagent and various combinations reagents disclosed herein.

Referring now to FIG. 1 there is shown a method in which reagents (1, 2) are added as concentrates (or optionally as diluted products), and reagents are added as concentrates or as diluted products. Additional diluent, not shown, can be added as an optional input to any of the depictions of the invention for generation of the biocides, such that any biocides may be batch diluted on-site according to embodiments of the invention. A setup optional mixer may be employed to aid mixing of the different reagents as needed. The non-chlorinated halogen biocide as produced in the tank may then be introduced into the process water system (7) needing to be treated, or in a particular application of use (7), as described below with respect to Applications of Use. The introduction may be by way of a pump (6). The non-chlorinated halogen biocide is produced in the wide space (4) and is then introduced into the process water system needing to be treated.

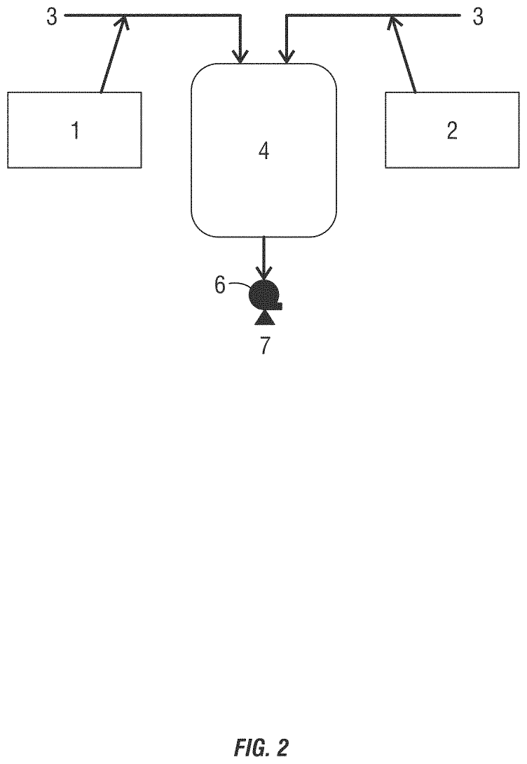

Referring now to FIG. 2 there is shown a method in which reagents (1, 2) are diluted continuously as they are introduced into the wide space (4). Reagents (1, 2) and diluent (3) may be blended in any order. In at least one embodiment not all components are diluted. The setup may contain an optional in-line or static mixer to aid mixing of one or more chemical components and the diluent. Also, the setup may include a mixer in the tank to aid in the blending of the different solutions. The biocide as produced in the tank is then introduced into the process water system requiring treatment.

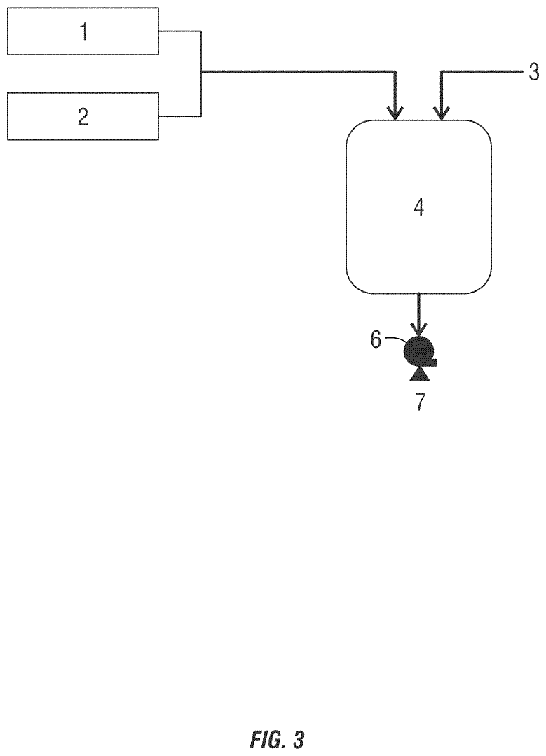

Referring now to FIG. 3 there is shown a method in which reagents (1, 2) are either concentrates or diluted and are mixed with each other prior to being introduced into the tank. The setup may contain an optional in-line mixer to aid mixing of the biocide and the diluent. Also, the setup may include a mixer in the tank to aid in the blending of the different solutions. The diluent can optionally be introduced into the tank in a separate stream.

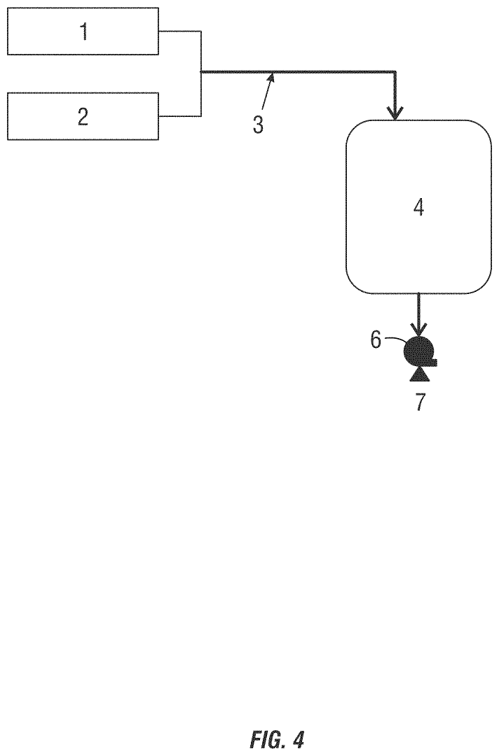

Referring now to FIG. 4 there is shown a method in which reagents (1, 2) can be mixed prior to entering the tank followed by the addition of the diluent to the conduit before entering the wide space (4). Reagents (1, 2) may be concentrates or diluted prior to blending. The setup may contain an optional in-line mixer to aid in the blending of the different solutions. Also, the setup may include a mixer in the tank to aid in efficient blending of the different solutions.

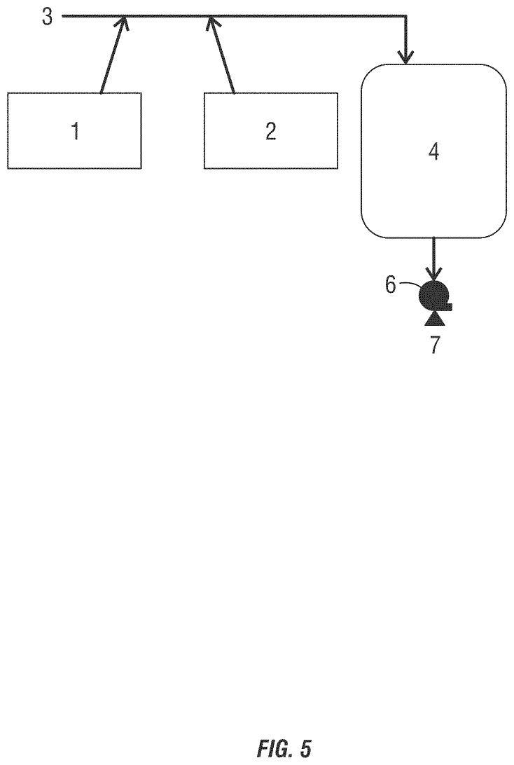

Referring now to FIG. 5 there is shown a method in which reagents (1, 2) are added sequentially to a stream of the diluent. The combination of reagents (1, 2) result in the formation of the biocide, which is then introduced into the wide space (4) along with the diluent. The setup may contain an optional in-line mixer to aid mixing of the chemical components and the diluent. Also, the setup may include a mixer in the tank to aid in efficient mixing of the different solutions.

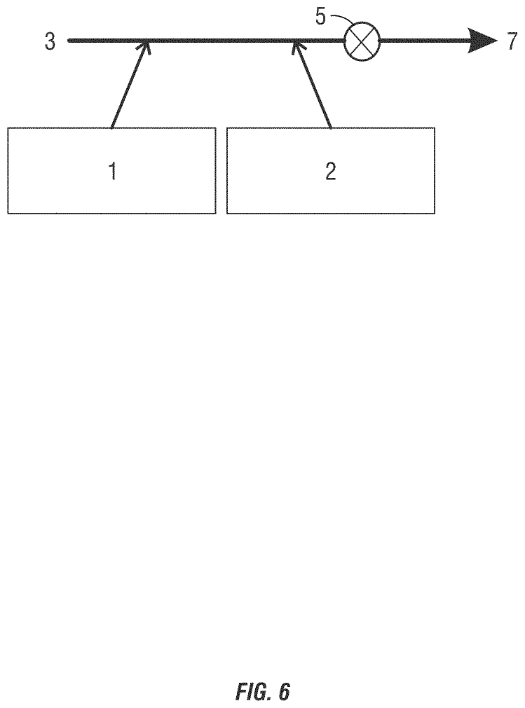

Referring now to FIGS. 6-13 there are shown methods in which reagents (1, 2) are synchronously or asynchronously combined in a diluted form (concentrate added to a diluent) via a controller device, such as a PLC device or a timer, or manually and the resulting biocide is introduced, synchronously or asynchronously, into the process to be treated. In this method, any number of chemical components can be introduced into the diluent stream. The diluent can be water or any other liquid stream appropriate for the dilution of the chemical components. The method may comprise a valve (5) to control the flow. A solid arrow line after the valve (5), depicts a continuous flow while a dashed line represents an interrupted or discontinuous flow.

Referring now to FIG. 6 there is shown a method in which reagents (1, 2) are added sequentially into the conduit in a continuous manner and the feed of the resulting biocide to the process being treated is continuous.

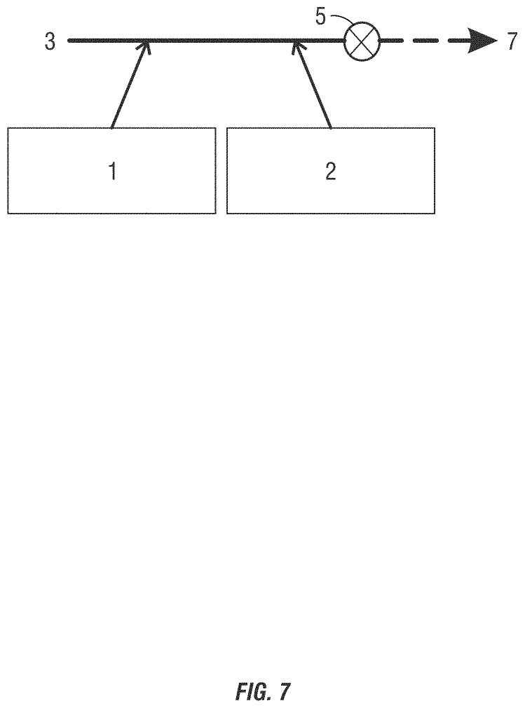

Referring now to FIG. 7 there is shown a method in which reagents (1, 2) are added sequentially into the conduit in a continuous manner but the feed of the resulting biocide to the process being treated is discontinuous.

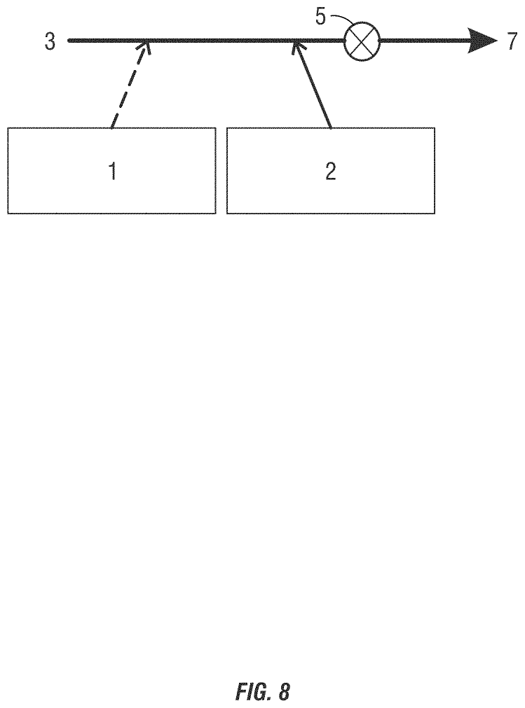

Referring now to FIGS. 8, 9, 10, and 11 there are shown a method in which reagents (1, 2) are added sequentially into the conduit but the addition of one of reagents is periodic. The feed of the resulting biocide to the process being treated can be either continuous or periodic.

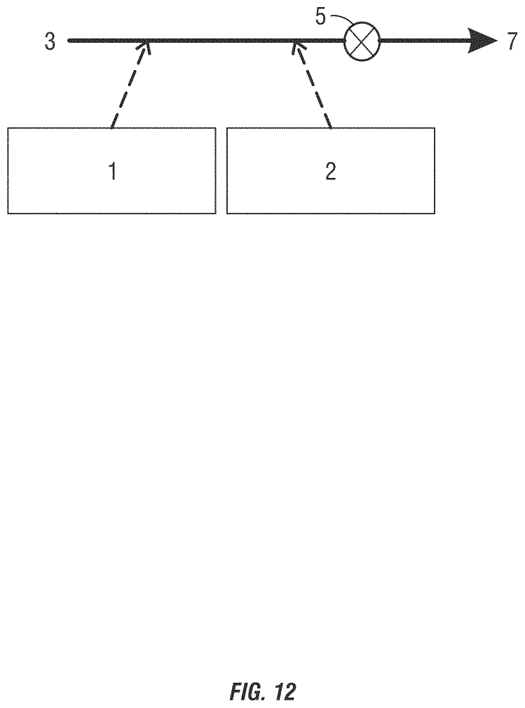

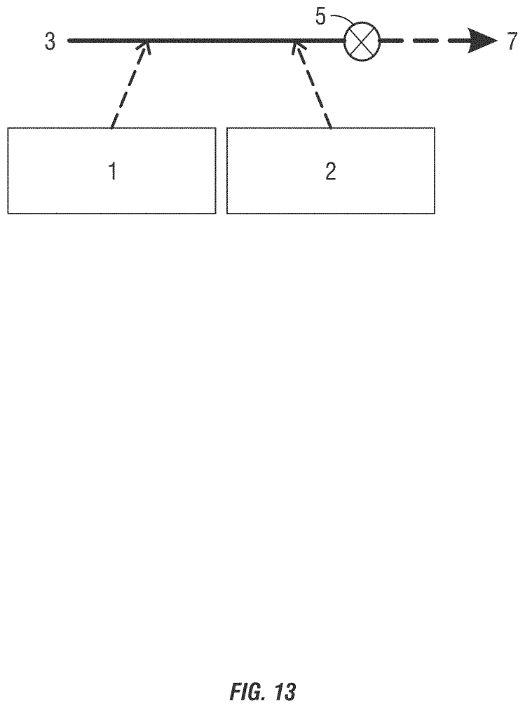

Referring now to FIGS. 12 and 13 there are shown methods in which reagents (1, 2) are added sequentially into the conduit but the addition of all the chemical components is periodic. The feed of the resulting biocide to the process being treated can be either continuous or periodic.

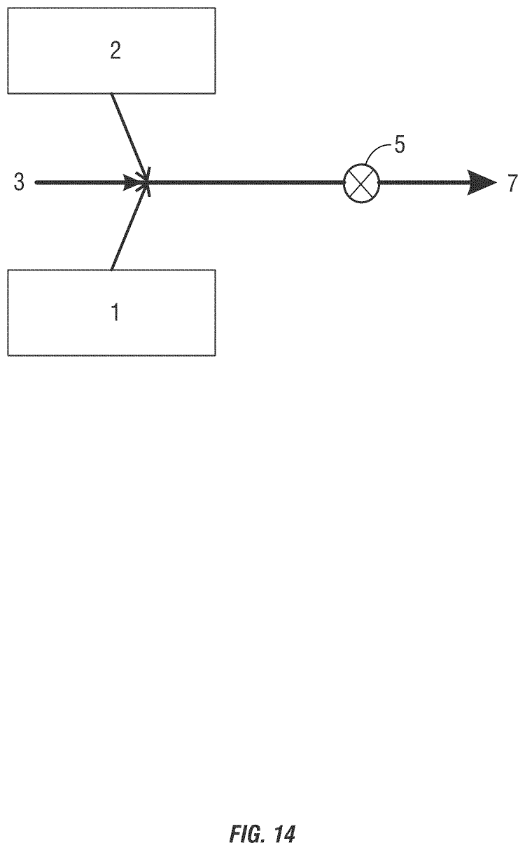

Referring now to FIGS. 14, 15, 16, 17, 18, and 19 there are shown methods in which reagents (1, 2) are added simultaneously at the same location in the conduit and the addition of all the reactants can be continuous or periodic. The feed of the resulting biocide to the process being treated can be either continuous or periodic.

Methods and Applications of Use

The biocides and methods of generating the same according to the invention are suitable for various industries and applications of use. The biocides and methods of generating the same are applicable to all industries that can employ biocides for aqueous system treatments for microbial control, including in water treatment processes, or as referred to herein as process water systems. In particular, the compositions and methods are particularly well suited for the use of the produced halogenated, non-chlorine oxidants for microbial and macrofouling control. Exemplary types of industrial processes in which the biocides and methods of the present invention can be applied generally include raw water processes, waste water processes, industrial water processes, municipal water treatment, food and beverage processes, pharmaceutical processes, electronic manufacturing, utility operations, pulp and paper processes, mining and mineral processes, transportation-related processes, textile processes, plating and metal working processes, laundry and cleaning processes, leather and tanning processes, personal care formulation additives and paint processes.

Further exemplary applications for oxidants in microbial and macrofouling control include: potable water systems; hot and cold water systems (such as spas, pools, Jacuzzis); decorative fountains; fruit and vegetable wash, including rinse and mist systems; flume water systems; industrial cooling water systems, including open recirculating, closed loop, and once through systems; an on-site point of use blending system for cleaning and sanitation, including for example a two bottle blending spray or soak system for sanitizing hard surfaces; and industrial process water systems. As referred to herein, process water systems suitable for treatment for microbial control include, but are not limited to: biofouling control or cleaning of RO membrane systems, raw water treatment, food and beverage clean-in-place (CIP) applications, treatment of waste water systems, ballast water systems, machine chests, head box waters, yellow or gray water systems, automotive wash water systems, metal working fluids, shower water, washers, thermal processing waters, brewing liquids, fermentation liquids, hard surface sanitization liquids, ethanol/bio-fuels process waters, pretreatment and utility waters, membrane system liquids, ion-exchange bed liquids, water used in the process/manufacture of paper, ceiling tiles, fiber board, or microelectronics, E-coat liquids, electrodeposition liquids, process cleaning liquids, oil exploration services liquids, oil well completion fluids, oil well workover fluids, drilling additive fluids, oil fracturing fluids, treated oil fracturing fluids, oil and gas wells, flowline water systems, natural gas water systems, and any combination thereof. Those skilled in the art will ascertain these are non-limiting and exemplary applications of industrial process water systems suitable treatment for microbial control.

Additional description of applications of use for biocide compositions is set forth in U.S. Pat. Nos. 6,840,251, 7,252,096 and 8,668,779, along with U.S. Publication Nos. 2008/0149570 and 2012/0165407 each of which is incorporated herein by reference in its entirety.

In an aspect of the invention, one or more components of the oxidizing, non-chlorinated halogenated biocide compositions are suitable for improving the oxidative state of the media being treated. In an exemplary embodiment, the one or more components of the solid, oxidizing, non-chlorinated halogenated biocide compositions alter the oxidation state of ions such as Fe, and Mn.

In an aspect of the invention, one or more components of the oxidizing, non-chlorinated halogenated biocide compositions are suitable for remediation of water systems contaminated with specific ions, such as bromide, arsenic or selenium.

In an aspect of the invention, one or more components of the oxidizing, non-chlorinated halogenated biocide compositions are suitable for blending with another chemistry, during the process, that may impart a buffering capacity or pH adjustment function. In an exemplary aspect, the biocide compositions may cause a change in pH of at least about 1, at least about 2, at least about 3, at least about 4, at least about 5, or greater.

In an aspect of the invention, one or more components of the oxidizing, non-chlorinated halogenated biocide compositions are suitable for blending using a mixing device, such as a static mixer for blending of liquid lines.

In an aspect of the invention, one or more components of the invention may be encapsulated or coated to improve the stability of the component. This aspect will be most useful if a one component system is designed where the different components are combined in the same solid form. Encapsulation or coating of one or more components will prevent the premature contact (such as during storage) and resulting reaction between the different components. The encapsulation or coating will release the reactive component following removal of the encapsulation/coating material upon solubilization or breakup during dissolution in water. In various aspects, the solid or liquid concentrate, oxidizing, non-chlorinated halogenated biocide composition is diluted to form a biocide use solution, in embodiments where a single solid composition comprising the halogen source and oxidizing agent (along with additional components including the solidification agent and optional functional ingredients). In other embodiments, the solid, oxidizing, non-chlorinated halogenated biocide composition can be provided as a multi-part solid composition providing the halogen source and oxidizing agent (along with additional components including the solidification agent and optional functional ingredients) in more than one solid composition. In such embodiments, the combining of the two or three part solid biocide composition to generate the biocide use solution in situ includes the combining of the reagents of the solid biocide composition with at least one precursor to the solid, oxidizing, non-chlorinated halogenated biocide composition to generate the biocide use solution in situ, and allowing all the reagents of the solid biocide composition to come into contact and mix with each other.

Upon generation of the non-chlorinated halogenated biocide composition, the step of contacting the use solution comprising from about 0.1 ppm to about 1000 ppm oxidizing, non-chlorinated halogenated biocide to a surface or water system in need of microbial and macrofouling control is completed. In other aspects, the biocide use solution can comprise from about 0.1 ppm to about 750 ppm, from about 0.1 ppm to about 500 ppm, or from about 0.1 ppm to about 100 ppm oxidizing, non-chlorinated halogenated biocide.

In various aspects, the surface or water system contacted by the use solution is a potable water system, hot and cold water system, decorative fountain, fruit and vegetable wash, rinse and/or mist system, flume water system, industrial cooling water system, on-site point of use blending system for cleaning and sanitation, industrial process water system, sea water, or combinations thereof. In other aspects, the industrial process water system for biofouling control or cleaning of is a reverse osmosis (RO) membrane systems, raw water treatment, food and beverage clean-in-place (CIP) application, treatment of waste water systems, ballast water systems, machine chests, head box waters, yellow or gray water systems, automotive wash water systems, metal working fluids, shower water, washers, thermal processing waters, brewing liquids, fermentation liquids, hard surface sanitization liquids, ethanol/bio-fuels process waters, pretreatment and utility waters, membrane system liquids, ion-exchange bed liquids, water used in the process/manufacture of paper, ceiling tiles, fiber board, or microelectronics, E-coat liquids, electrodeposition liquids, process cleaning liquids, oil exploration services liquids, oil well completion fluids, oil well workover fluids, drilling additive fluids, oil fracturing fluids, treated oil fracturing fluids, oil and gas wells, flowline water systems, natural gas water systems, and any combination thereof. In still other aspects, the industrial process water system and/or sea water comprises a precursor to the solid, oxidizing, non-chlorinated halogenated biocide composition, such as the precursor to the solid, oxidizing, non-chlorinated halogenated biocide composition in the industrial process water system and/or sea water is the non-chlorine halogen source (e.g. sodium bromide).

According to various applications of use of the oxidizing non-chlorinated halogenated biocide, the use composition has a pH greater than about 5, greater than about 6, greater than about 7, greater than about 8, greater than about 9, or greater than about 10. According to various applications of use of the oxidizing non-chlorinated halogenated biocide, the use composition is maintained at a temperature from about 20 degrees Celcius to about 25 degrees Celcius, preferably approaching room temperature. As one skilled in the art will ascertain, the maintaining of an alkaline pH and room temperature of the oxidizing non-chlorinated halogenated biocide beneficially prevents adverse reactions and off-gassing of the produced oxidizing biocides.

All publications and patent applications in this specification are indicative of the level of ordinary skill in the art to which this invention pertains. All publications and patent applications are herein incorporated by reference to the same extent as if each individual publication or patent application was specifically and individually indicated as incorporated by reference.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

The measurement of free residual oxidant, or the formed oxidant from solid non-chlorinated oxidizing biocide compositions according to the invention were analyzed. The free residual oxidant, or the formed oxidant, was measured by the DPD method (HACH Method 8021) using a HACH colorimeter or an iodometric titration method. The DPD method of free and total chlorine measurement is the most widely used method, it is easy to perform, requires little apparatus, is inexpensive and adapts well to field test situations. In this test, DPD (N,N-diethyl-p-phenylenediamine) is oxidized by chlorine, causing the development of a magenta (red/pink) color. The intensity of color is directly proportional to the chlorine concentration. DPD reacts in much the same way with other oxidants, including bromine, chlorine dioxide, hydrogen peroxide, iodine, ozone and permanganate. For the measurement of Total oxidant Potassium Iodide is added to the reaction to determine combined available forms and total oxidant levels. The oxidizing chemistry oxidizes the iodide to iodine; then the liberated iodine reacts with DPD to form the magenta color.

To evaluate the disclosed invention, two different formulations were tested. The first formulation comprised of an oxygen source in the form of a Potassium Peroxymonosulfate salt dissolved in water and a halide source in the form of an alkali earth metal salt of bromine (sodium bromide) dissolved in water. This first formulation did not include a stabilizing chemistry as a component in the reaction mixture. Therefore this reaction was a two component system containing two ingredients. The second formulation also comprised of an oxygen source in the form of a Potassium Peroxymonosulfate salt dissolved in water and a halide source in the form of an alkali earth metal salt of bromine (sodium bromide) dissolved in water. However, this second formulation included a stabilizing chemistry as a separate component in the reaction mixture. This stabilizing chemistry component was part of the halide component source. Therefore this reaction was also a two component system but containing three ingredients. To manage the experimental setup and generated data, the ratio of blending of the two components ranged from 2:1 (oxygen source:halide source) to 1:6 (oxygen source:halide source).

Preliminary studies on the biocidal efficacy of the produced oxidant were conducted using plate count data. Plate count is a standard method for measuring biocidal efficacy of any compound against microorganisms. In this method, microorgansims are suspended in the test matrix that could be water from specific locations or types or a standard preparation or a buffer solution. The test matrix with the microorganisms is divided into different parts and to each is then added a known quantity of the biocide. The concentration of the biocide added to each part would be different to get a dose response. The treated water matrix is then placed under the target temperature conditions (incubated) for the desired period of time to serve as the contact time. The contact time can vary depending on the microorganisms and the biocide being tested. Following incubation/exposure time, an aliquot of the sample is collected and following dilution in sterile water or buffer, the sample is plated on a plate/film containing appropriate nutrients in a solidified gel state. The plates are then incubated at the appropriate temperature for a period of time depending on the microorganisms being evaluated, generally 24-48 hrs. Following incubation the developed colonies, each considered to represent growing from a single microorganism, are counted and kill efficacy evaluated in comparison to the population count from the untreated sample that was otherwise treated similarly. Plate Count data as shown in Table 2 confirms biocidal efficacy of the solid non-chlorinated oxidizing biocide compositions according to the invention. The compositions according to the invention were compared to the control bleach.

TABLE 2

| Test Composition | Biocounts |
|---|---|
| Control - test matrix alone | 7.1 × 1e7 |
| Test Matrix + KMPS* (0.5 ppm dose) | 4.7 × 1e7 |
| Test Matrix + KMPS* (3.0 ppm dose) | 5.9 × 1e7 |
| Test Matrix + Bleach (3.0 ppm dose) | 1.4 × 1e7 |
| Test Matrix + 3 ppm dose (KI** + KMPS*) | 1.0 × 1e6 |
| Test Matrix + 3 ppm dose (NaBr*** + KMPS*) | 1.0 × 1e6 |

*KMPS—Potassium Monoperoxysulfate
**KI—Potassium Iodide
***NaBr—Sodium Bromide

As shown in Table 2, the compositions according to the invention performed at least as well or better than bleach. Moreover, the results indicate that in these compositions the oxidizing agent was not contributing to biocidal efficacy, which would be modified based on selection of the oxidizing agent for further biocidal kill.

### Example 2

Additional biocide preparations were evaluated according to the invention.

Potassium peroxymonosulfate (Oxone) and Sodium Bromide (NaBr) reaction at a Mole ratio 1:2 (Oxone:NaBr). In a 250 ml stoppered volumetric flask 1.15 gm of oxone solution (22% w/w) was added. To the oxone solution 0.50 gm of NaBr solution (34% w/w) was added slowly. Once the addition of NaBr is over the volumetric flask was closed with stopper and the volumetric flask was covered. The flask was kept aside in fume hood for 15 minutes. After 15 minutes the reaction mixture in the flask was diluted carefully (without allowing gaseous bromine to escape) to 250 ml. This solution is 181.6 times diluted solution (i.e. 1.38 ml volume of original reaction mixture was diluted to 250 ml). This solution was further diluted to 137.931 times (i.e. 0.725 ml diluted to 100 ml) to record the free residual chlorine (FRC) and total residual chlorine (TRC), also alternatively termed as Free Residual Oxidant (FRO) and Total Residual Oxidant (TRO), respectively.

Potassium peroxymonosulfate (Oxone) and a stabilized Sodium Bromide (commercially available as ControlBrom or CB70) reaction at a Mole ratio 1:1.5 (Oxone:CB70). In a 20 ml amber colored glass bottle with screw cap 1.15 gm of oxone solution (22% w/w) was added. To the oxone solution 0.42 gm of CB70 was added slowly. Once the addition of CB70 is over the glass bottle was closed with cap. The flask was kept aside in fume hood for 15 minutes. After 15 minutes, 1 ml of the reaction mixture in the flask was diluted carefully (without allowing gaseous bromine to escape) to 25 ml. This solution is 25 times diluted solution (i.e. 1 ml volume of original reaction mixture was diluted to 25 ml). This solution was further diluted to 1000 times (i.e. 1 ml diluted to 1000 ml) to record the FRC and TRC.

Mole Ratio Optimization:

Effect of molar conc. of Oxone and CB70 on HOBr species generation was studied. The maximum FRC was generated with 1:1.5 mole ratio (Oxone:CB70) which was constant till 1:2 and decreased slightly till 1:3 mole ratio (Table 3).

TABLE 3
TRC and FRC analysis of Oxone + CB 70 at different mole ratio

| Mole ratio | TRC | FRC* |
|---|---|---|
| (Oxone:CB70) | (ppm) | (ppm) |
| 1:0 | 80000 | 1500 |
| 1:0.5 | 35000 | 8500 |
| 1:1 | 28500 | 20000 |
| 1:1.5 | 35250 | 31750 |
| 1:1.7 | 36000 | 31500 |
| 1:2 | 35500 | 31750 |
| 1:2.5 | 36000 | 29250 |
| 1:3 | 34000 | 28500 |

*FRC measured after 3 min.

In case of Oxone+NaBr, maximum FRC was generated with 1:2 mole ratio which was constant till 1:2 and decreased slightly till 1:6 mole ratio (Table 5).

TABLE 4
TRC and FRC analysis of Oxone + NaBr at different mole ratio

| | | |
|---|---|---|
| Mole Ratio | TRC | FRC* |

| Oxone | NaBr | (ppm) | (ppm) |
|---|---|---|---|
| 1 | 0.5 | 37500 | 8250 |
| 1 | 1 | 21250 | 9250 |
| 1 | 1.5 | 12000 | 11250 |
| 1 | 1.7 | 14000 | 13000 |
| 1 | 2 | 23000 | 20500 |
| 1 | 2.5 | 21500 | 19000 |
| 1 | 3 | 23250 | 20750 |
| 1 | 4 | 22500 | 20000 |
| 1 | 5 | 21000 | 19000 |
| 1 | 6 | 19000 | 17250 |

*FRC measured after 20 seconds.

### Example 3

Efficacy studies were performed at different pH conditions by using Pseudomonas stock and TVC stock employing the biocides generated according to Example 2.

Effect of pH

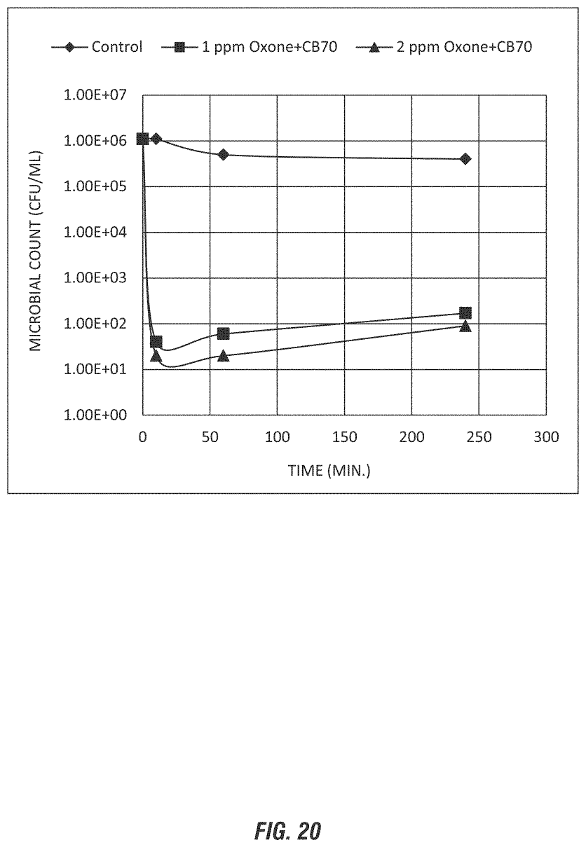

At pH 7.26: Kill efficacy study was performed by using phosphate buffer solution at pH 7.26. As shown in FIG. 20 and Table 5, Pseudomonas kill efficacy at pH 7.26 by using Oxone+CB70 formulation outperformed the control (no biocide).

TABLE 5
FRC measurement w.r.t. time during kill study

| | |
|---|---|
| Time | FRC (3 min.) |

| (min.) | 1 ppm | 2 ppm |
|---|---|---|
| 0 | 0.7 | 1.5 |
| 10 | 0.56 | 1.41 |
| 60 | 0.42 | 1.2 |
| 240 | 0.23 | 1.02 |

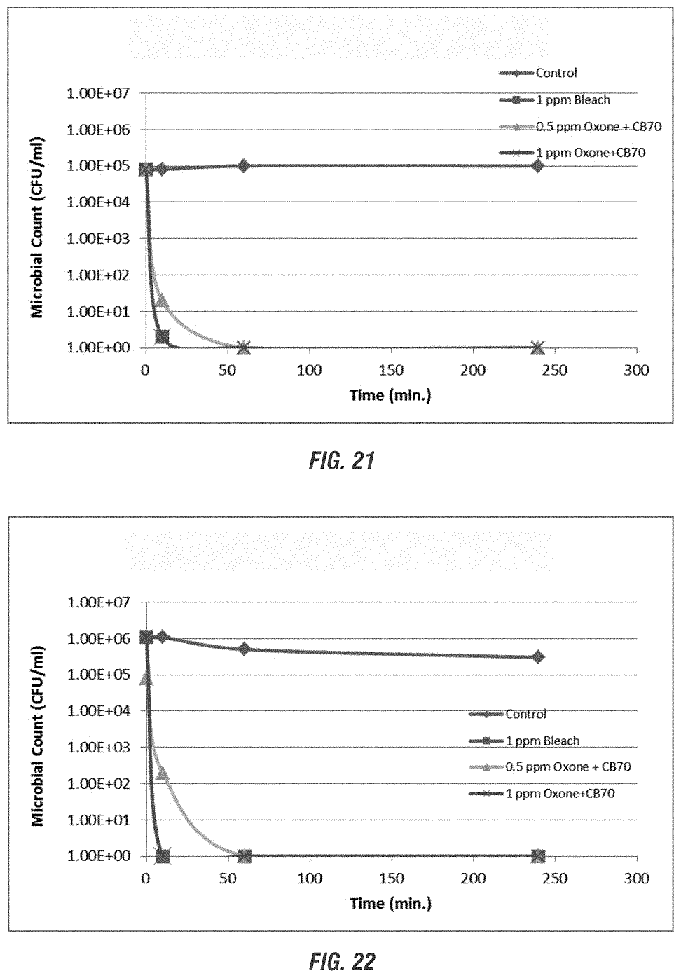

In the Control (without biocide) sample the microbio count was observed to be 10⁶ CFU/ml. Oxone+CB70 is effective at 1 ppm dosage as 4 log reduction was observed within 10 min. of incubation time (FIG. 21). Little increase in count was observed with time in both 1 ppm and 2 ppm dosage but it was not in log scale. 24 hrs data showed no re-growth but count in control was lower down (FIG. 22). The buffer solution after addition of Pseudomonas count showed 0.3 to 0.5 ppm demand after dosing the Oxone+CB70. The FRC decreases with time while after 24 hrs it was not detectable it confirms biocide consumption (Table 5) due to system demand.

At pH 8.26: Kill efficacy study was performed by using phosphate buffer solution at pH 8.2 and the performance of Oxone+CB70 was compared with 1 ppm bleach. As shown in FIG. 21 and Table 6, Pseudomonas kill efficacy at pH 8.2 by using Oxone+CB70 formulation perform equivalent to bleach with log reduction although at a faster rate compared to bleach.

TABLE 6
FRC measurement w.r.t. time during kill study

| Time | FRC (20 sec.) | FRC (3 min) | |
|---|---|---|---|
| (min.) | 1 ppm Bleach | 0.5 ppm Ox + CB70 | 1 ppm Ox + CB70 |
| 0 | 0.33 | 0.39 | 0.79 |
| 10 | 0.16 | 0.29 | 0.61 |
| 60 | 0.06 | 0.13 | 0.36 |
| 240 | 0.03 | 0.04 | 0.15 |
| 2440 | 0.03 | 0.03 | 0.06 |

In the Control (without biocide) sample the microbial count was observed to be 10⁶ CFU/ml. Oxone+CB70 at 0.5 and 1 ppm dosage showed 4 log reduction within 10 min. of time while 0.5 ppm bleach required 1 hr to get 4 log reduction (FIG. 21). The 1 ppm bleach consumption is faster than Oxone+CB70 (Table 6) due to system demand.

At pH 9.15: Kill efficacy study was performed by using borate buffer solution at pH 9.15 and the performance of Oxone+CB70 was compared with 1 ppm bleach. As shown in FIG. 22 and Table 7, Pseudomonas kill efficacy at pH 9.15 by using Oxone+CB70 formulation perform equivalent to bleach.

TABLE 7
FRC measurement w.r.t. time during kill study

| Time | FRC (20 sec.) | FRC* (3 min.) | |
|---|---|---|---|
| (min.) | 1 ppm Bleach | 0.5 ppm Ox + CB70 | 1 ppm Ox + CB70 |
| 0 | 0.38 | 0.32 | 0.57 |
| 10 | 0.28 | 0.21 | 0.43 |
| 60 | 0.18 | 0.12 | 0.31 |
| 240 | 0.03 | 0.07 | 0.13 |
| 2440 | — | — | — |

Control (without biocide) sample the microbiology count was observed to be 10⁶ CFU/ml. Oxone+CB70 at 0.5 and 1 ppm dosage showed 4 log reduction within 10 min. of time while 0.5 ppm bleach required 1 hr to get 4 log reduction. The 1 ppm bleach consumption is faster than Oxone+CB70 due to system demand. The performance of 1 ppm bleach at 9.15 pH was inferior as compared to 1 ppm bleach at 8.2 pH while Oxone+CB70 showed similar performance even at higher (9.15) pH. This clearly indicates that Oxone+CB70 which generates HOBr have good stability even at higher pH as compared to HOCl.

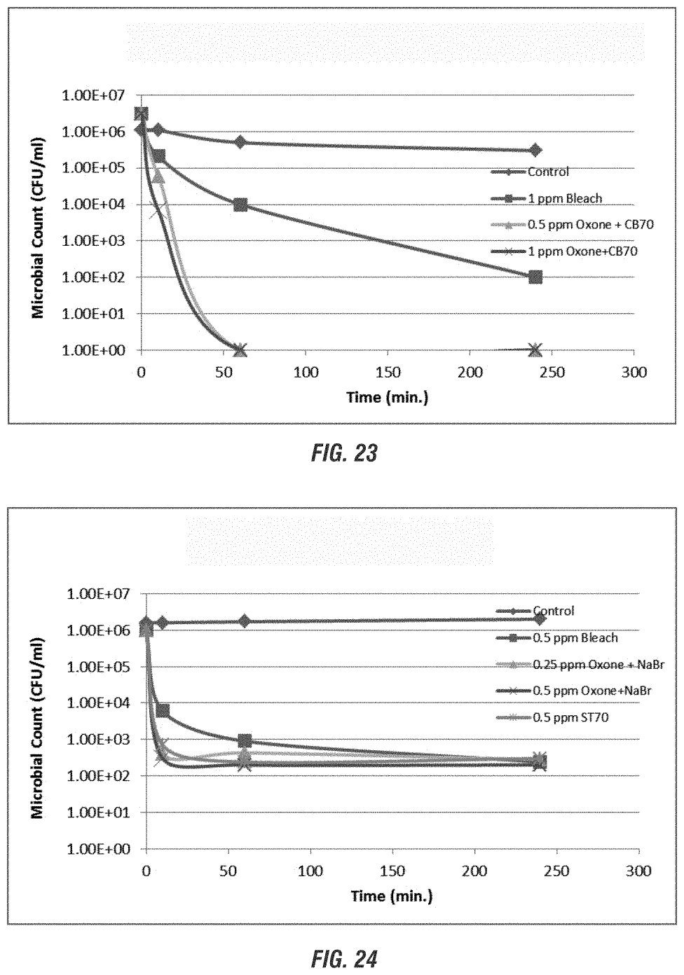

Efficacy study with simulated water at pH 8.2 were also conducted. Water coming into industrial processes can be from different sources such as municipal, well, lakes or rivers. The simulated water employed in this example is a standardized water matrix that is prepared to simulate a certain kind of water composition that can provide certain components that are generally present in the incoming water. The simulated water contains calcium chloride, magnesium sulfate and carnonate, thus providing some hardness and alkalinity to the water matrix. The kill efficacy study was performed by using Pseudomonas as well as TVC stock. As shown in FIG. 23 and Table 8 are the comparisons of Pseudomonas kill efficacy at pH 8.2 by using Oxone+CB70 formulation in comparison with Bleach.

TABLE 8
FRC measurement w.r.t. time during kill study

| Time | FRC (20 sec.) | FRC* (3 min.) | |
|---|---|---|---|
| (min) | 1 ppm Bleach | 0.5 ppm Ox + CB70 | 1 ppm Ox + CB70 |
| 0 | 0.18 | 0.36 | 0.77 |
| 10 | 0.03 | 0.31 | 0.64 |
| 60 | 0.01 | 0.16 | 0.34 |
| 240 | 0.01 | 0.02 | 0.03 |
| 2440 | — | — | — |

The Control (without biocide) sample had a microbio count observed to be >10⁶ CFU/ml. Oxone+CB70 at 0.5 ppm dosage showed 4 log reduction after 10 min. of incubation time while the performance was similar to 1 ppm Oxone+CB70 and 1 ppm bleach after 1 hr of incubation time.

As further shown in FIG. 24 is the TVC kill efficacy at pH 8.2 by using Oxone+NaBr formulation in comparison with Bleach. In case of TVC stock, Oxone+NaBr at 0.25 ppm dosage was better than 0.5 ppm bleach and showed similar performance to 0.5 ppm ST70. Oxone+NaBr at 0.25 ppm and 0.5 ppm dosage showed 4 log reduction in 1 hr of incubation time and showed almost similar kill efficacy as observed with Pseudomonas stock.

The inventions being thus described, it will be obvious that the same may be varied in many ways. Such variations are not to be regarded as a departure from the spirit and scope of the inventions and all such modifications are intended to be included within the scope of the following claims. The above specification provides a description of the manufacture and use of the disclosed compositions and methods. Since many embodiments can be made without departing from the spirit and scope of the invention, the invention resides in the claims.

1-15. (canceled)

16. A method of utilizing and/or employing an oxidizing, non-chlorinated halogenated biocide composition comprising:
providing a one or more part solid system comprising:
an oxidizing, non-chlorinated halogenated solid biocide composition comprising:
a halogen source, wherein the halogen source is not chlorine; and
an oxidizing agent, wherein the oxidizing agent is a non-chlorine containing oxygen donor;
wherein the molar ratio of halogen source to oxidizing agent is from about 10:1 to about 0.1:1;
either (a) diluting the biocide composition to form a biocide use solution; or (b) combining the two or three part biocide composition to generate the biocide use solution in situ; or (c) combining reagents of the biocide composition with at least one precurosor to the oxidizing, non-chlorinated halogenated biocide composition to generate the biocide use solution in situ;
allowing all the reagents of the biocide composition to come into contact and mix with each other; and
contacting the use solution comprising from about 0.1 ppm to about 1000 ppm oxidizing, non-chlorinated halogenated biocide to a surface or water system in need of microbial and macrofouling control.

17. The method of claim 16, wherein the biocide use solution comprises from about 0.1 ppm to about 100 ppm oxidizing, non-chlorinated halogenated biocide.

18. The method of claim 16, wherein the combining of the two or three part biocide composition to generate the biocide use solution in situ blends the biocide compositions or diluted compositions in a synchronous or asynchronous feeding.

19. The method of claim 18, wherein the synchronous or asynchronous feeding is either continuous or intermittent.

20. The method of claim 16, wherein the solid biocide composition is stable for at least about 6 months.

21. The method of claim 16, wherein the surface or water system contacted by the use solution is a potable water system, hot and cold water system, decorative fountain, fruit and vegetable wash, rinse and/or mist system, flume water system, industrial cooling water system, on-site point of use blending system for cleaning and sanitation, industrial process water system, sea water, or combinations thereof.

22. The method of claim 21, wherein the industrial process water system is a reverse osmosis (RO) membrane systems, raw water treatment, food and beverage clean-in-place (CIP) application, treatment of waste water systems, ballast water systems, machine chests, head box waters, yellow or gray water systems, automotive wash water systems, metal working fluids, shower water, washers, thermal processing waters, brewing liquids, fermentation liquids, hard surface sanitization liquids, ethanol/bio-fuels process waters, pretreatment and utility waters, membrane system liquids, ion-exchange bed liquids, water used in the process/manufacture of paper, ceiling tiles, fiber board, or microelectronics, E-coat liquids, electrodeposition liquids, process cleaning liquids, oil exploration services liquids, oil well completion fluids, oil well workover fluids, drilling additive fluids, oil fracturing fluids, treated oil fracturing fluids, oil and gas wells, flowline water systems, natural gas water systems, and any combination thereof.

23. The method of claim 21, wherein the halogen source is bromide or salts thereof, iodide or salts thereof, or combinations of the same.

24. The method of claim 21, wherein the halogen source is a bromide salt of an alkali earth metal and/or an iodide salt of an alkali earth metal or urea, or an ammoniated bromide salt and/or iodide salt.

25. The method of claim 21, wherein the oxidizing agent is hydrogen peroxide or a peroxide donor, mono peroxy sulfate salt, persulfate salt, percarbonate salt, perborate salt, or combinations thereof.

26. The method of claim 21, wherein the biocide composition further comprises a solidification agent, and wherein the biocide composition is a powder, a flake, a granule, a tablet, a puck, a briquette, a brick, a solid block, or a pressed solid.

27. The method of claim 26, wherein the solidification agent is a cellulose, carbonate, urea, inorganic hydratable salt, organic hydratable salt, or other inert thickeners.

28. The method of claim 21, wherein the biocide composition further comprises a stabilizing agent, surfactant and/or an additional functional ingredient.

29. The method of claim 28, wherein the stabilizing agent is a sulfamate, isocyanurate, hydantoin or combinations thereof, and wherein the additional functional ingredient is a corrosion inhibitor, scale inhibitor or combinations thereof, and wherein the stabilizing agent is present from about 0.1 wt. % to about 50 wt. % of the composition.

30. The method of claim 21, wherein the biocide composition is stable for at least about 6 months.

31. The method of claim 21, wherein the biocide use solution has a pH of between about 7 and about 12.
